(19) United States
(12) Patent Application Publication
(10) Pub. No.: US 2025/0347941 A1
(43) Pub. Date: Nov. 13, 2025

(54) Microring Resonator Device Heater with Improved Reliability

(71) Applicant: Ayar Labs, Inc., San Jose, CA (US)

(72) Inventors: Sidney Buchbinder, Santa Clara, CA (US); Hayk Gevorgyan, San Jose, CA (US); John Fini, Albany, CA (US); Anatol Khilo, Lexington, MA (US); Derek Kita, Santa Clara, CA (US); Derek Van Orden, San Francisco, CA (US); Dries Vercruysse, Millbrae, CA (US); Manuj Singh, San Jose, CA (US)

(21) Appl. No.: 19/275,758

(22) Filed: Jul. 21, 2025

Related U.S. Application Data
(63) Continuation-in-part of application No. 19/054,079, filed on Feb. 14, 2025.
(60) Provisional application No. 63/554,935, filed on Feb. 16, 2024.
(60) Provisional application No. 63/674,195, filed on Jul. 22, 2024.

(51) Int. Cl. G02F 1/025

(52) U.S. Cl. CPC G02F 1/025

(57) ABSTRACT

An electro-optical semiconductor chip includes a ring-shaped optical waveguide circumscribing an interior region of a microring resonator device. A bus optical waveguide extends past the ring-shaped optical waveguide, such that an optical coupling region exists therebetween. A doped ring of silicon is disposed within the interior region of the microring resonator device. An inner region of silicided silicon is formed along an inner edge of the doped ring of silicon. An outer region of silicided silicon is formed along an outer edge of the doped ring of silicon. A first plurality of electrical contacts electrically contact the outer region of silicided silicon. A second plurality of electrical contacts electrically contact the inner region of silicided silicon. A voltage differential between the first and second pluralities of electrical contacts controls an electrical current flow through the doped ring of silicon to control a temperature of the ring-shaped optical waveguide.

### CROSS-REFERENCE TO RELATED APPLICATIONS

This application claims priority under 35 U.S.C. 119 (e) to U.S. Provisional Patent Application No. 63/674,195, filed on Jul. 22, 2024, the disclosure of which is incorporated herein by reference in its entirety for all purposes. This application is a continuation-in-part (CIP) application under 35 U.S.C. 120 of prior U.S. patent application Ser. No. 19/054,079, filed on Feb. 14, 2025, which claims priority under 35 U.S.C. 119 (e) to U.S. Provisional Patent Application No. 63/554,935, filed on Feb. 16, 2024. The disclosure of each above-identified patent application is incorporated herein by reference in its entirety for all purposes.

### BACKGROUND OF THE INVENTION

### 1. Field of the Invention

The present invention relates to optical data communication.

### 2. Description of the Related Art

Optical data communication systems operate by modulating laser light to encode digital data patterns within optical data signals. In some embodiments, an optical modulator is used to modulate continuous wave laser light to generate the modulated laser light that conveys the encoding of digital data patterns. The modulated laser light is transmitted through an optical data network from a sending node to a receiving node. The modulated laser light having arrived at the receiving node is de-modulated to obtain the original digital data patterns from the optical data signals. In some embodiments, a photodiode is used to detect light of an optical data signal and convert the detected light into a photocurrent that can be processed through electrical circuitry to demodulate the optical data signal to obtain the original digital data pattern from the optical data signal. The transmission of light through the optical data network includes transmission of light through optical fibers and transmission of light between optical fibers and photonic integrated circuits. It is within this context that the present invention arises.

### SUMMARY OF THE INVENTION

In an example embodiment, an electro-optical semiconductor chip is disclosed. The electro-optical semiconductor chip includes a ring-shaped optical waveguide circumscribing an interior region of a microring resonator device. The electro-optical semiconductor chip also includes a bus optical waveguide that extends past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a doped ring of silicon disposed within the interior region of the microring resonator device concentric with the ring-shaped optical waveguide. The electro-optical semiconductor chip also includes an inner region of silicided silicon formed along an inner edge of the doped ring of silicon. The electro-optical semiconductor chip also includes an outer region of silicided silicon formed along an outer edge of the doped ring of silicon. The electro-optical semiconductor chip also includes a first plurality of electrical contacts disposed to electrically contact the outer region of silicided silicon. The electro-optical semiconductor chip also includes a second plurality of electrical contacts disposed to electrically contact the inner region of silicided silicon. A voltage differential between the first plurality of electrical contacts and the second plurality of electrical contacts is used to control an electrical current flow through the doped ring of silicon to control a temperature of the ring-shaped optical waveguide.

In an example embodiment, an electro-optical semiconductor chip is disclosed. The electro-optical semiconductor chip includes a ring-shaped optical waveguide. The electro-optical semiconductor chip also includes a bus optical waveguide that extends past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a doped-silicon non-silicided region disposed outside of the ring-shaped optical waveguide and within thermal communication with the ring-shaped optical waveguide. The electro-optical semiconductor chip also includes an inner contact region formed of silicided silicon along an inner side of the doped-silicon non-silicided region. The electro-optical semiconductor chip also includes an outer contact region formed of silicided silicon along an outer side of the doped-silicon non-silicided region. The electro-optical semiconductor chip also includes a first plurality of electrical contacts disposed to electrically contact the inner contact region. The electro-optical semiconductor chip also includes a second plurality of electrical contacts disposed to electrically contact the outer contact region. A voltage differential between the first plurality of electrical contacts and the second plurality of electrical contacts is used to control an electrical current flow through the doped-silicon non-silicided region to control a temperature of at least a portion of the ring-shaped optical waveguide.

In an example embodiment, an electro-optical semiconductor chip is disclosed. The electro-optical semiconductor chip includes a ring-shaped optical waveguide. The electro-optical semiconductor chip also includes a bus optical waveguide that extends past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a tungsten-via-based resistive heater disposed outside of the ring-shaped optical waveguide on a silicon structure that is in thermal communication with the ring-shaped optical waveguide.

In an example embodiment, an electro-optical semiconductor chip is disclosed. The electro-optical semiconductor chip includes a ring-shaped optical waveguide. The electro-optical semiconductor chip also includes a bus optical waveguide that extends past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a contiguous tungsten bar via structure disposed inside of the ring-shaped optical waveguide on a silicon structure that is in thermal communication with the ring-shaped optical waveguide. The electro-optical semiconductor chip also includes a first contact structure electrically connected to a first end of the contiguous tungsten bar via structure. The electro-optical semiconductor chip also includes a second contact structure electrically connected to a second end of the contiguous tungsten bar via structure. A voltage differential between the first contact structure and the second contact structure controls an amount of electrical current flow through the contiguous tungsten bar via structure to control an amount of heat generated within the contiguous tungsten bar via structure to control a heating of the silicon structure on which the contiguous tungsten bar via structure is formed.

### BRIEF DESCRIPTION OF THE DRAWINGS

FIG. 1 shows a top view of a microring resonator device that implements a doped-silicon non-silicided resistive radial-current heater, in accordance with some embodiments.

FIG. 2 shows a vertical cross-section slice through the doped-silicon non-silicided resistive radial-current heater, reference as View A-A in FIG. 1, in accordance with some embodiments.

FIG. 3 shows a top view of a doped-silicon non-silicided resistive radial-current heater, in accordance with some embodiments.

FIG. 4A shows a top view of a ring modulator that implements a first interdigitated diode configuration within a first optical coupling region and that implements a second interdigitated diode configuration within a second optical coupling region, in accordance with some embodiments.

FIG. 4B shows a top view of a configuration of full-height (full-thickness) silicon formed within the cladding material, in accordance with some embodiments.

FIG. 4C shows a top view of the configuration of full-height (full-thickness) silicon with portions of the full-height (full-thickness) silicon etched away to form the partial-height (partial-thickness) silicon regions, in accordance with some embodiments.

FIG. 4D shows a top view of the partially formed ring modulator of FIG. 4C with formation of the inner electrical contacts, the inner electrical contacts, the inner electrical contacts, and the outer electrical contacts, in accordance with some embodiments.

FIG. 4E shows a top view of the partially formed ring modulator of FIG. 4D with formation of the N-type doping regions, and the tab-shaped N-type doping regions, in accordance with some embodiments.

FIG. 4F shows the top view of the ring modulator of FIG. 4E with formation of the P-type doping regions, and the tab-shaped P-type doping regions, in accordance with some embodiments.

FIG. 4G shows a top view of the ring modulator of FIG. 4F with the N-type doping regions, and the tab-shaped N-type doping regions electrically connected to a first electrical node by way of an electrical conductor, in accordance with some embodiments.

FIG. 4H shows a top view of the ring modulator with the doped-silicon non-silicided resistive radial-current heater of FIG. 3 disposed inside of the ring modulator, in accordance with some embodiments.

FIG. 4I shows a close-up view of a region, as referenced in FIG. 4H, of the doped-silicon non-silicided resistive radial-current heater within the ring modulator, in accordance with some embodiments.

FIG. 5 shows the top view of the ring modulator of FIG. 4A implementing a first doped-silicon non-silicided resistive heater and a second doped-silicon non-silicided resistive heater outside of the rib ring, in accordance with some embodiments.

FIG. 6 shows a top view of the ring modulator of FIG. 4A implementing each of the first doped-silicon non-silicided resistive heater outside of the rib ring, the second doped-silicon non-silicided resistive heater outside of the rib ring, and the doped-silicon non-silicided resistive radial-current heater of FIG. 3 inside of the ring modulator, in accordance with some embodiments.

FIG. 7A shows a top view of a ring modulator that implements a circuitous interdigitated diode configuration that extends through both a first optical coupling region and a second optical coupling region, in accordance with some embodiments.

FIG. 7B shows a top view of a configuration of full-height (full-thickness) silicon formed within the cladding material, in accordance with some embodiments.

FIG. 7C shows a top view of the configuration of full-height (full-thickness) silicon with portions of the full-height (full-thickness) silicon etched away to form the partial-height (partial-thickness) silicon regions, in accordance with some embodiments.

FIG. 7D shows a top view of the partially formed ring modulator of FIG. 7C having the N-type doping region and the P-type doping region formed thereon, in accordance with some embodiments.

FIG. 7E shows an isolated top view of the N-type doping regions, in accordance with some embodiments.

FIG. 7F shows an isolated top view of the P-type doping region, including the P-type doped outer rim region and multiple P-type doped spoke regions, in accordance with some embodiments.

FIG. 7G shows an isolated view of the N-type doping regions and the P-type doping region positioned relative to each other as in the ring modulator, in accordance with some embodiments.

FIG. 7H shows the top view of the ring modulator of FIG. 7D with the N-type doping regions electrically connected to a first electrical node by way of an electrical conductor, in accordance with some embodiments.

FIG. 7I shows a top view of the ring modulator of FIG. 7A with the doped-silicon non-silicided resistive radial-current heater of FIG. 3 disposed inside of the ring modulator, in accordance with some embodiments.

FIG. 7J shows a top view of the ring modulator of FIG. 7H with the doped-silicon non-silicided resistive radial-current heater of FIG. 3 disposed inside of the ring modulator, and with the rib ring of the ring modulator surrounded by the outer optical cladding material, in accordance with some embodiments.

FIG. 8 shows a top view of a microring resonator device that implements a tungsten-via-based resistive heater outside of a ring-shaped optical waveguide, in accordance with some embodiments.

FIG. 9 shows a top view of a microring resonator device that implements a tungsten-via-based resistive heater inside of a ring-shaped optical waveguide, in accordance with some embodiments.

FIG. 10 shows a top view of a microring resonator device that implements a tungsten-via-based resistive heater outside of a ring-shaped optical waveguide, along an optical waveguide, and along an optical waveguide, in accordance with some embodiments.

FIG. 11 shows a top view of a microring resonator device that implements a tungsten-via-based resistive heater both outside and inside of a ring-shaped optical waveguide, in accordance with some embodiments.

FIG. 12 shows a top view of a tungsten-via-based resistive heater formed along both sides of an optical waveguide, in accordance with some embodiments.

FIG. 13A shows a vertical cross-section through a thermo-optic phase shifter, in accordance with some embodiments.

FIG. 13B shows the vertical cross-section through the thermo-optic phase shifter of FIG. 13A, along with an electrical schematic of the thermo-optic phase shifter corresponding to the physical structure of the thermo-optic phase shifter, in accordance with some embodiments.

FIG. 13C shows the vertical cross-section through the thermo-optic phase shifter of FIG. 13A, in which the vertical thickness (tₒₓ) of the electrical insulator material is increased, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

The embodiments disclosed herein relate to optical data communication. Optical data communication systems operate by modulating laser light to encode digital data patterns within optical data signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The modulated laser light is transmitted through an optical data network from a sending node to a receiving node. The modulated laser light having arrived at the receiving node is de-modulated to obtain the original digital data patterns from the optical data signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal.

Optical cavities are used in a variety of applications in optical data communication systems, in various devices, such as lasers, optical modulators, optical splitters, optical routers, optical switches, and optical detectors, among others. In various applications and configurations, optical cavities may show strong wavelength selectivity. For this reason, optical cavities are useful in systems that rely on multiple optical data signals transmitting information at different wavelengths. In some embodiments, optical cavities are configured as ring resonators and/or disk resonators to enable applications in which light that is coupled from an input optical waveguide into the optical cavity of the ring/disk resonator is either efficiently routed to a separate output optical waveguide, or absorbed within the optical cavity of the ring/disk resonator at specific wavelengths. Also, optical cavities, such as ring/disk resonators, are useful in sensing applications, such as in biological or chemical sensing applications in which a high concentration of optical power is needed in a small area.

In various embodiments, electrical data signals are used to drive optical modulation within an optical cavity of a ring/disc modulator. In various embodiments, electrical signal repeater/amplifier devices, such as CMOS (complementary metal oxide semiconductor) repeater/amplifier devices, are implemented within integrated circuits to mitigate/reduce electrical signal delay along an electrical signal conveyance pathway that extends from an origination point of the electrical signal to a destination point of the electrical signal. Electrical repeater/amplifier devices, such as CMOS repeater/amplifier devices, play an important role in transmitting ultra-high-speed data through electrical wires for either within chip (inter-chip) data communication and/or between chips (chip-to-chip) data communication. In some embodiments, particularly in optical data communication devices and/or systems, an electrical data signal that is used to drive optical modulation within a ring/disc modulator has to be sent along a electrical signal conveyance pathway from an origination point of the electrical data signal to the optical cavity that is used to modulate a beam of continuous wave laser light to transfer the digital data present within the electrical data signal into an optical data signal within the optical domain. In these embodiments, one or more CMOS repeater/amplifier devices are implemented along the electrical signal conveyance pathway to mitigate/reduce delay and/or mitigate/reduce signal loss associated with transmission of the electrical data signal from its origination point to the optical cavity of the ring/disc modulator.

Microring resonator device-based modulators and filters are important components in wavelength-division multiplexed (WDM) systems, since they provide compact integration. Thermal tuning of the resonant wavelengths for a microring resonator device is often required. For example, in various embodiments, thermal tuning of resonant wavelengths for a microring resonator device is implemented to compensate for ambient temperature changes, to match a light source wavelength not known at the time of fabrication, and/or to compensate for fabrication uncertainties. In various embodiments, thermal tuning of resonant wavelengths for a given microring resonator device is achieved by embedding resistive heaters in close proximity to the given microring resonator device.

It is desirable to achieve a large resonant wavelength tuning range for a given microring resonator device. For example, in various embodiments, having a larger resonant wavelength tuning range for a given microring resonator device enables the resonant wavelength tuning of the given microring resonator device to cover a broader range of ambient temperatures and/or a broader range of source light wavelengths. In various embodiments, to achieve a larger resonant wavelength tuning range for a given microring resonator device, a heater associated with the given microring resonator device needs to operate at high electrical current and high temperature.

Microring resonator device heater failure and reliability are a major issues in designing a microring resonator device-based WDM system. The reliability of a microring resonator device heater limits the resonant wavelength tuning range available to the heater, and in turn limits the temperature range over which the WDM system can operate. Therefore, it is desirable to have microring resonator device heater designs that provide improved resilience to high temperatures and high electrical current conditions. To this end, various embodiments are disclosed herein for microring resonator device heaters that have increased reliability and increased resonant wavelength tuning range, and that provide for increased temperature range over which the WDM system can operate.

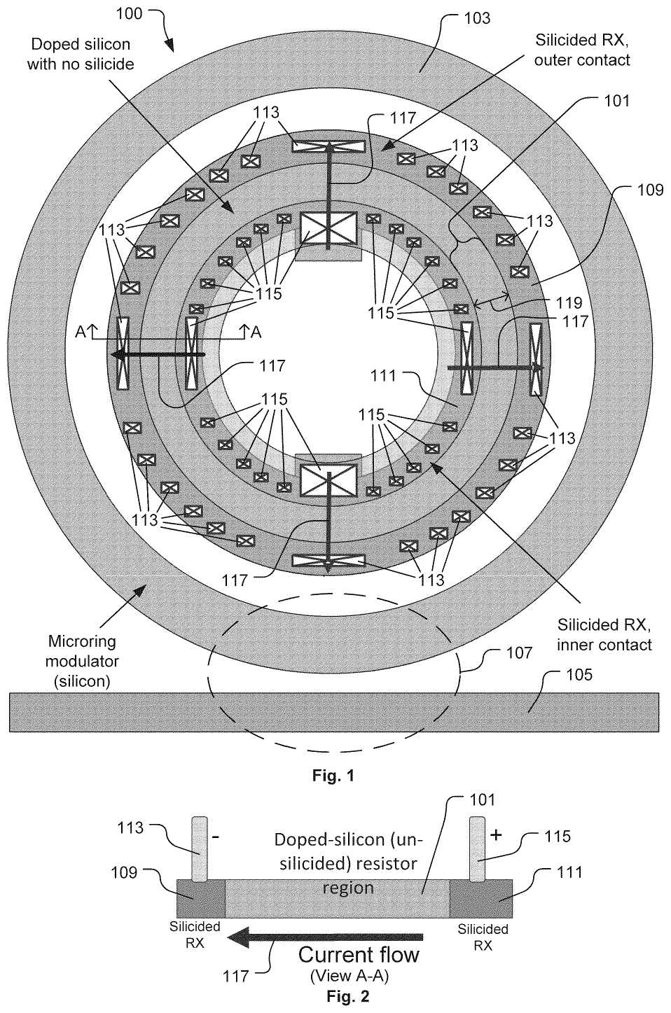

Various embodiments are disclosed herein for providing localized heating in the center of the microring modulator through the use of one or more heating device(s) formed within into the electro-optic chip. FIG. 1 shows a top view of a microring resonator device 100 that implements a doped-silicon non-silicided resistive radial-current heater 101, in accordance with some embodiments. In some embodiments, the microring resonator device 100 and the doped-silicon non-silicided resistive radial-current heater 101 are formed within an electro-optic semiconductor chip. The microring resonator device 100 includes a ring-shaped optical waveguide 103. In some embodiments, the ring-shaped optical waveguide 103 is positioned within an evanescent optical coupling distance of at least one optical waveguide 105, with an optical coupling region 107 established around a location of closest approach of the optical waveguide 105 to the ring-shaped optical waveguide 103. In some embodiments, the optical waveguide 105 is a bus optical waveguide. In some embodiments, the optical waveguide 105 is a drop optical waveguide.

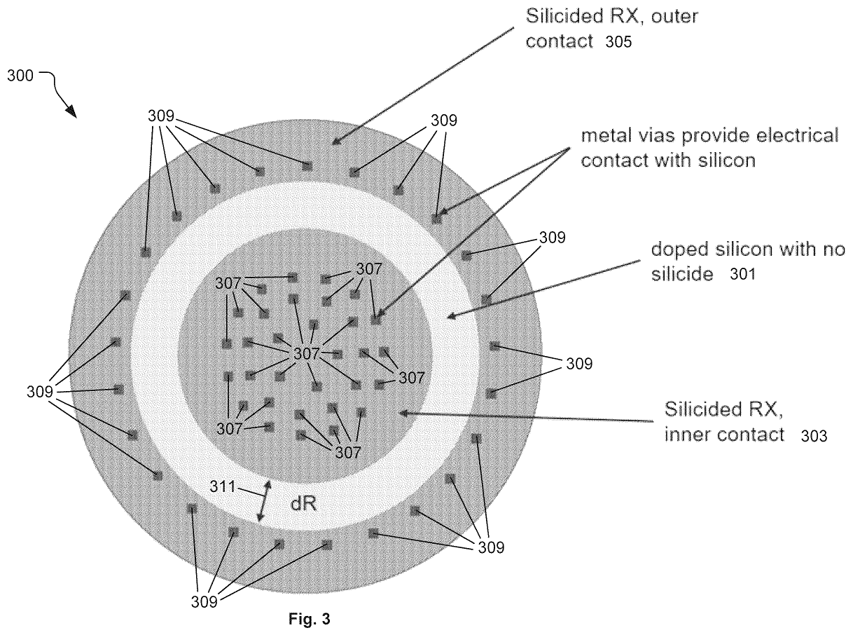

FIG. 2 shows a vertical cross-section slice through the doped-silicon non-silicided resistive radial-current heater 101, referenced as View A-A in FIG. 1, in accordance with some embodiments. The doped-silicon non-silicided resistive radial-current heater 101 is formed within the region that is circumscribed by the ring-shaped optical waveguide 103. In some embodiments, the doped-silicon non-silicided resistive radial-current heater 101 is configured to have a ring-shape that is substantially concentric with the ring-shaped optical waveguide 103 of the microring resonator device 100. The doped-silicon non-silicided resistive radial-current heater 101 is formed between an outer ring of silicided silicon 109 and an inner ring of silicided silicon 111. In some embodiments, the doped-silicon non-silicided resistive radial-current heater 101, the outer ring of silicided silicon 109, and the inner ring of silicided silicon 111 are formed as respective portions of a same monolithic silicon structure. It should be understood that the outer ring of silicided silicon 109 and the inner ring of silicided silicon 111 are electrically conductive, and the doped-silicon non-silicided resistive radial-current heater 101 is electrically resistive.

A first plurality of electrical contacts 113 are disposed to electrically contact the outer ring of silicided silicon 109. A second plurality of electrical contacts 115 are disposed to electrically contact the inner ring of silicided silicon 111. A first voltage is applied to the first plurality of electrical contacts 113, such that the outer ring of silicided silicon 109 is at the first voltage. A second voltage is applied to the second plurality of electrical contacts 115, such that the inner ring of silicided silicon 111 is the second voltage. A difference between the first voltage and the second voltage is controlled to cause a flow of electrical current between the inner ring of silicided silicon 111 and the outer ring of silicided silicon 109, as indicated by arrows 117. In some embodiments, such as shown in FIGS. 1 and 2, the first and second voltages are controlled so that the electrical current flows from the inner ring of silicided silicon 111 to the outer ring of silicided silicon 109, as indicated by arrows 117. However, in other embodiments, the first and second voltages are controlled so that the electrical current flows from the outer ring of silicided silicon 109 to the inner ring of silicided silicon 111.

As the electrical current flows between the inner ring of silicided silicon 111 and the outer ring of silicided silicon 109 and through the doped-silicon non-silicided resistive radial-current heater 101, heat is generated primarily in the doped-silicon non-silicided resistive radial-current heater 101. The electrical resistance of the doped-silicon non-silicided resistive radial-current heater 101 is much larger than the electrical resistance of each of the inner ring of silicided silicon 111 and the outer ring of silicided silicon 109, such that relatively little heat is generated in the each of the inner ring of silicided silicon 111 and the outer ring of silicided silicon 109. In some embodiments, the first plurality of electrical contacts 113 is formed as a dense collection of via structures, which pull excess heat out of the outer ring of silicided silicon 109. Also, in some embodiments, the second plurality of electrical contacts 115 is formed as a dense collection of via structures, which pull excess heat out of the inner ring of silicided silicon 111. Because excess heat is pulled out of the outer ring of silicided silicon 109 and out of the inner ring of silicided silicon 111, the doped-silicon non-silicided resistive radial-current heater 101 is less prone to thermally-induced damage.

The doping level of the doped-silicon non-silicided resistive radial-current heater 101 is set to achieve a target electrical resistance. In some embodiments, the target electrical resistance of the doped-silicon non-silicided resistive radial-current heater 101 is within a range extending from about 70 ohms to about 250 ohms. In some embodiments, the target electrical resistance of the doped-silicon non-silicided resistive radial-current heater 101 is within a range extending from about 100 ohms to about 200 ohms. In some embodiments, a target sheet electrical resistance of the doped-silicon non-silicided resistive radial-current heater 101 is within a range extending from about 1000 ohms per square-micrometer (μm²) to about 8000 ohms per μm². In some embodiments, the target sheet electrical resistance of the doped-silicon non-silicided resistive radial-current heater 101 is within a range extending from about 2000 ohms per μm² to about 5000 ohms per μm².

The effective width of the doped-silicon non-silicided resistive radial-current heater 101 is defined by its circumference. The effective length of the doped-silicon non-silicided resistive radial-current heater 101 is defined by its radial thickness, as shown by arrow 119. The effective width of the doped-silicon non-silicided resistive radial-current heater 101 is large, and the effective length of the doped-silicon non-silicided resistive radial-current heater 101 is small, which provides for a low electrical current density within the doped-silicon non-silicided resistive radial-current heater 101 for a given amount of power generated within the doped-silicon non-silicided resistive radial-current heater 101.

FIG. 3 shows a top view of a doped-silicon non-silicided resistive radial-current heater 300, in accordance with some embodiments. The doped-silicon non-silicided resistive radial-current heater 300 includes a doped silicon region 301 that does not have silicide. The doped-silicon non-silicided resistive radial-current heater 300 also includes an inner contact 303 that is formed by silicided silicon. The inner contact 303 is circumscribed by the doped-silicon non-silicided resistive radial-current heater 300. The inner contact 303 is in electrical contact with the doped-silicon non-silicided resistive radial-current heater 300. The doped-silicon non-silicided resistive radial-current heater 300 also includes an outer contact 305 that is formed by silicided silicon. The doped-silicon non-silicided resistive radial-current heater 300 is circumscribed by the outer contact 305. The doped-silicon non-silicided resistive radial-current heater 300 is in electrical contact with the outer contact 305. In some embodiments, such as shown in FIG. 3, the inner contact 303 is formed as a disc-shaped silicon structure. In some embodiments, the inner contact 303 is formed as an annular-shaped silicon structure, similar to the inner ring of silicided silicon 111 as shown in FIG. 1. A first collection of via structures 307 are formed in electrical connection with the inner contact 303. A second collection of via structures 309 are formed in electrical connection with the outer contact 305.

In some embodiments, the via structures 307 and the via structures 309 are formed in a manner that is consistent with conventional CMOS fabrication process design rules and requirements for via structures, such as by forming the via structures 307 and 309 to have a square horizontal cross-sectional shape. However, in some embodiments, at least some of the via structures 307 and the via structures 309 are formed in a manner that is not consistent with conventional CMOS fabrication process design rules and requirements for via structures, such as by forming the via structures 307 and 309 to have an elongated (non-square) horizontal cross-sectional shape. In some embodiments, the first collection of via structures 307 includes at least 10 via structures 307. In some embodiments, the first collection of via structures 307 provides a cumulative via structure 307 horizontal cross-sectional area of at least 0.1 μm². In some embodiments, the first collection of via structures 307 provides a cumulative via structure 307 horizontal cross-sectional area of at least 0.15 μm². In some embodiments, the second collection of via structures 309 includes at least 10 via structures 309. In some embodiments, the second collection of via structures 309 provides a cumulative via structure 309 horizontal cross-sectional area of at least about 0.1 μm². In some embodiments, the second collection of via structures 309 provides a cumulative via structure 309 horizontal cross-sectional area of at least about 0.15 μm².

A first voltage is applied to the first collection of via structures 307, such that the inner contact 303 is at a first voltage. A second voltage is applied to the second collection of via structures 309, such that the outer contact 305 is at a second voltage. A difference between the first voltage and the second voltage is controlled to cause a flow of electrical current between the inner contact 303 and the outer contact 305. In some embodiments, the first and second voltages are controlled so that the electrical current flows from the inner contact 303 to the outer contact 305. However, in other embodiments, the first and second voltages are controlled so that the electrical current flows from the outer contact 305 to the inner contact 303.

As the electrical current flows between the inner contact 303 and the outer contact 305 and through the doped silicon region 301, heat is generated primarily in the doped silicon region 301. The electrical resistance of the doped silicon region 301 is much larger than the electrical resistance of each of the inner contact 303 and the outer contact 305, such that relatively little heat is generated in the each of the inner contact 303 and the outer contact 305. In some embodiments, the first collection of via structures 307 is formed as a dense collection of via structures, which pull excess heat out of the inner contact 303. Also, in some embodiments, the second collection of via structures 309 is formed as a dense collection of via structures, which pull excess heat out of the outer contact 305. Because excess heat is pulled out of the inner contact 303 and out of the outer contact 305, the doped silicon region 301 is less prone to thermally-induced damage.

The doping level of the doped silicon region 301 is set to achieve a target electrical resistance. In some embodiments, the target electrical resistance of the doped silicon region 301 is within a range extending from about 70 ohms to about 250 ohms. In some embodiments, the target electrical resistance of the doped silicon region 301 is within a range extending from about 100 ohms to about 200 ohms. In some embodiments, the target sheet electrical resistance of the doped silicon region 301 is within a range extending from about 1000 ohms per μm² to about 8000 ohms per μm². In some embodiments, the target sheet electrical resistance of the doped silicon region 301 is within a range extending from about 2000 ohms per μm² to about 5000 ohms per μm².

The doped silicon region 301 has a radial thickness 311 defined large enough to accommodate formation of the inner contact 303 within the region circumscribed by the doped silicon region 301. In some embodiments, the radial thickness 311 of the doped silicon region 301 is within a range extending from about 0.1 μm to about 2 μm. In some embodiments, the radial thickness 311 of the doped silicon region 301 is sized large enough to avoid manufacturability issues, such as variations related to mask-overlay errors and/or dopant diffusion, among others. In some embodiments, the radial thickness 311 of the doped silicon region 301 is set to ensure that heat generated within the doped silicon region 301 is generated near the optical mode within an optical conveyance structure, e.g., ring-shaped optical waveguide, that is formed around the doped-silicon non-silicided resistive radial-current heater 300. Also, in some embodiments, the radial thickness 311 of the doped silicon region 301 is set to ensure that heat generated within the doped silicon region 301 is efficiently delivered to the optical conveyance structure that is positioned around the doped-silicon non-silicided resistive radial-current heater 300. In some embodiments, the radial thickness 311 of the doped silicon region 301 is within a range extending from about 0.1 μm to about 1 μm. In some embodiments, the radial thickness 311 of the doped silicon region 301 is within a range extending from about 0.2 μm to about 0.9 μm. In some embodiments, the radial thickness 311 of the doped silicon region 301 is within a range extending from about 0.3 μm to about 0.6 μm.

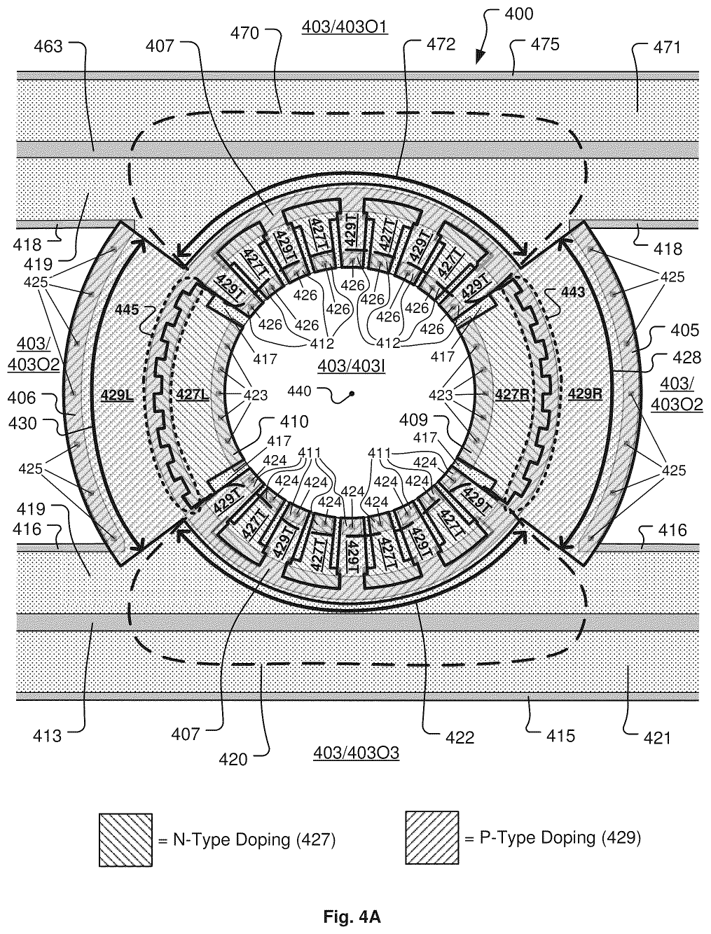

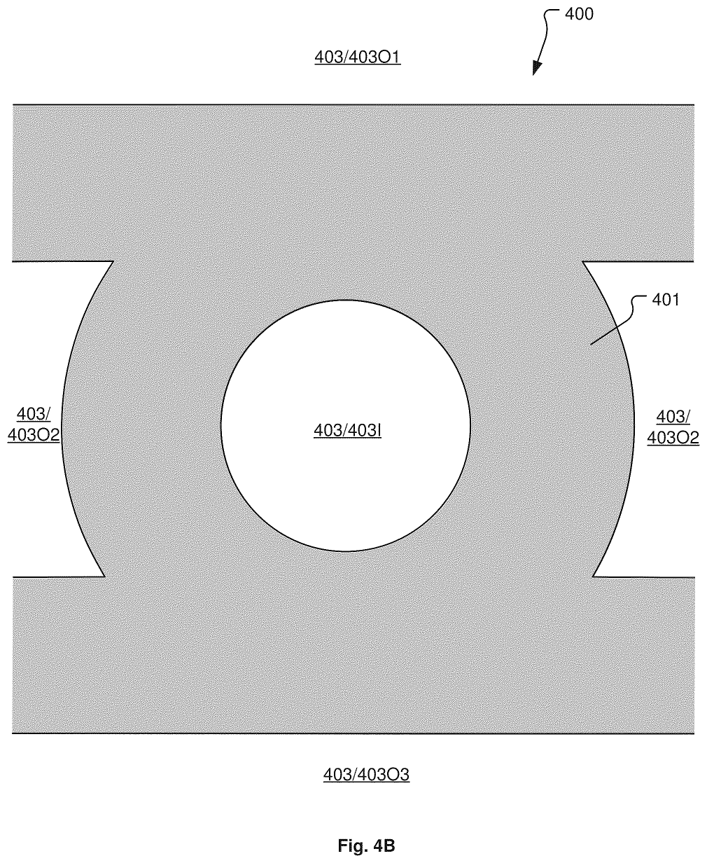

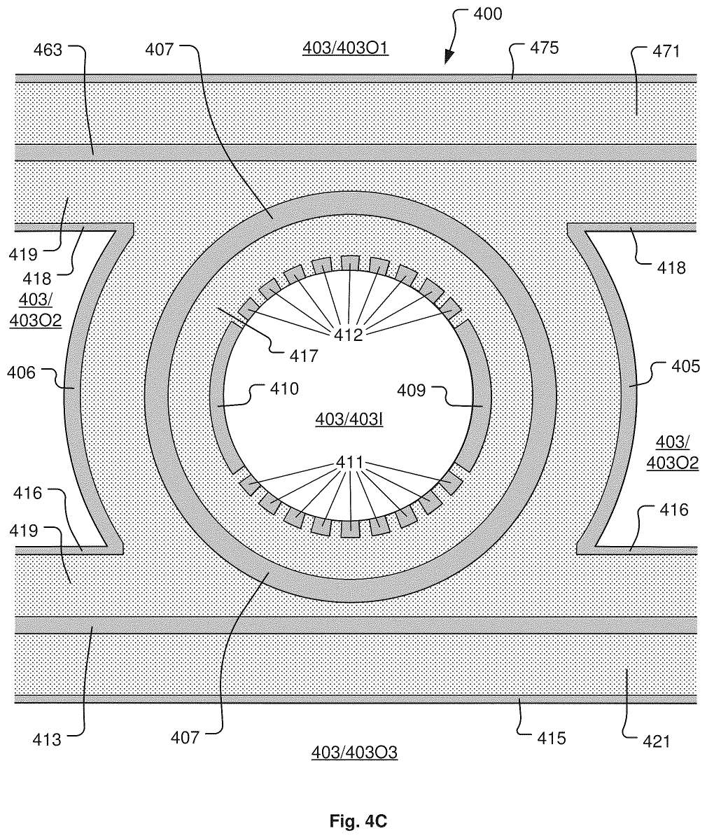

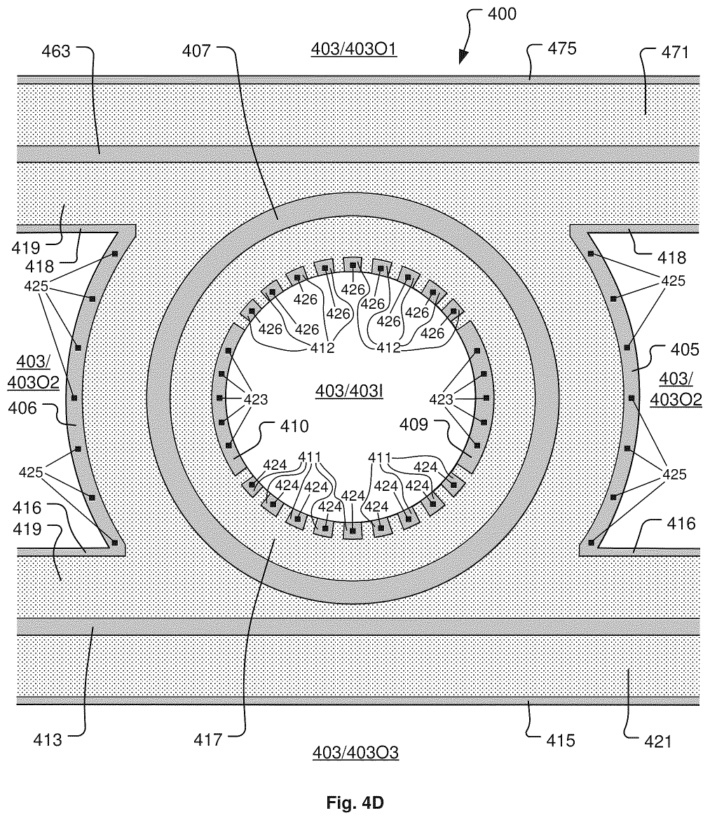

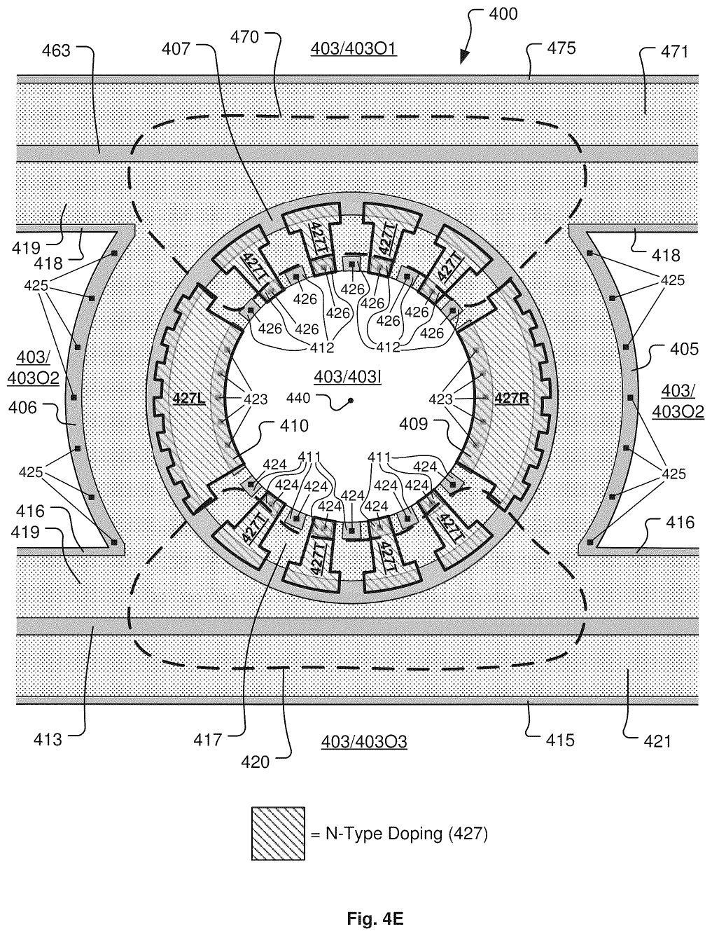

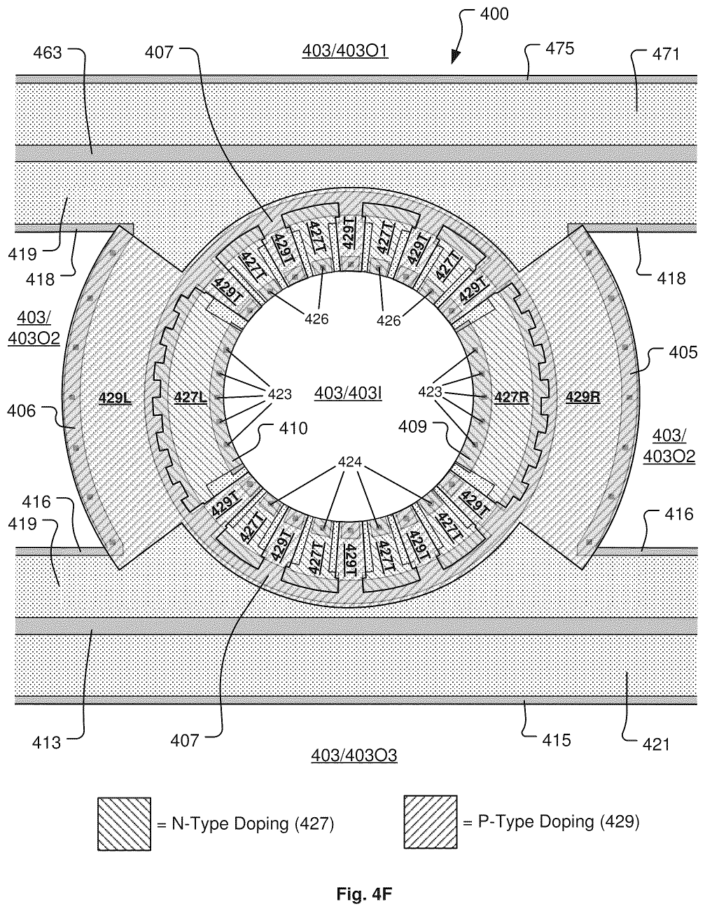

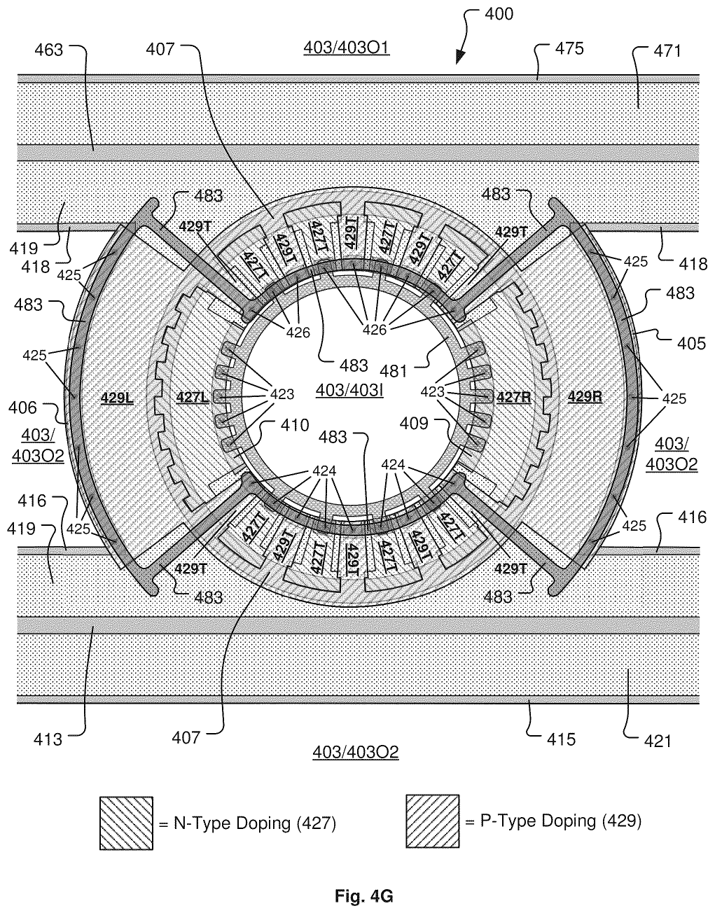

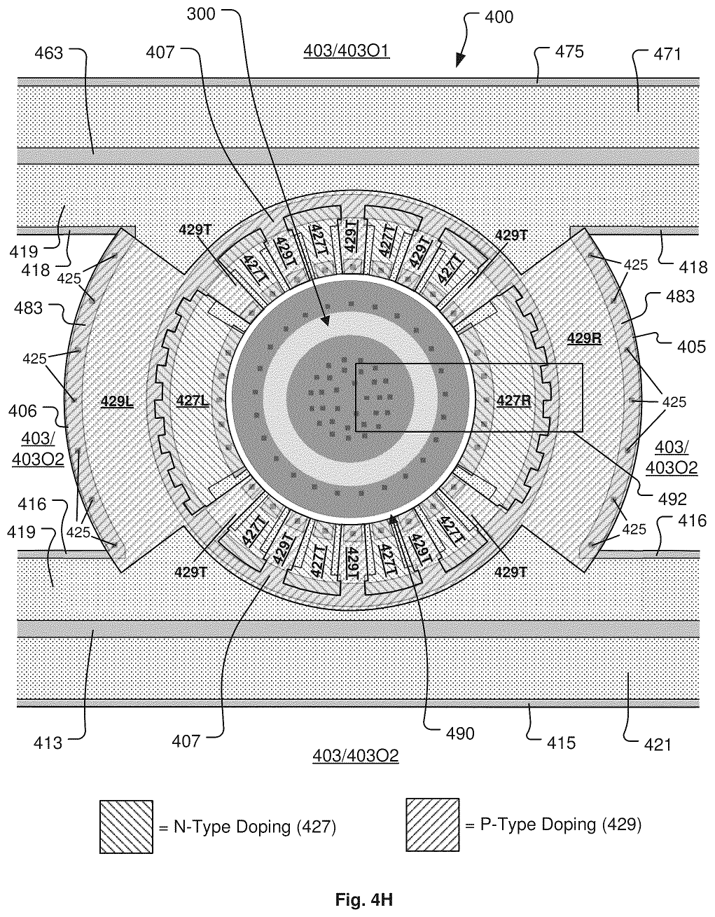

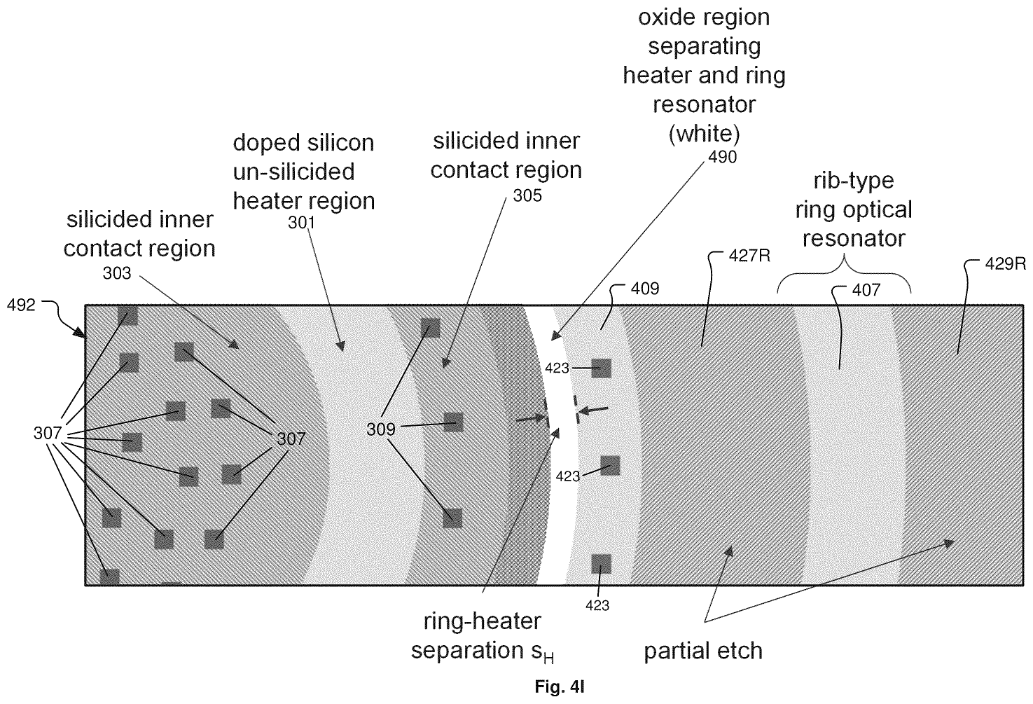

FIG. 4A shows a top view of a ring modulator 400 that implements a first interdigitated diode configuration within a first optical coupling region 420 and that implements a second interdigitated diode configuration within a second optical coupling region 470, in accordance with some embodiments. The first interdigitated diode configuration within the first optical coupling region 420 is formed by multiple tab-shaped N-type doping regions 427T and multiple tab-shaped P-type doping regions 429T, where the tab-shaped N-type doping regions 427T and the tab-shaped P-type doping regions 429T are alternately positioned with respect to each other. The first optical coupling region 420 is between a rib ring 407 of the ring modulator 400 and an optical waveguide 413. The second optical coupling region 470 is between the rib ring 407 of the ring modulator 400 and an optical waveguide 463. The rib ring 407 is formed as a rib optical waveguide that loops back into itself. A portion of the rib ring 407 extends through the optical coupling region 420. Another portion of the rib ring 407 extends through the optical coupling region 470. The ring modulator 400 is configured to optimize modulation efficiency while minimizing optical loss in each of the optical waveguide 413 and the optical waveguide 463. The ring modulator 400 is positioned so that the rib ring 407 is located within an evanescent optical coupling distance from the optical waveguide 413. The ring modulator 400 is also positioned so that the rib ring 407 is located within an evanescent optical coupling distance from the optical waveguide 463.

The rib ring 407 and each of the optical waveguide 413 and the optical waveguide 463 are formed as respective full-height (full-thickness) silicon regions. The rib ring 407 is surrounded by a partial-height (partial-thickness) silicon region 419. More specifically, the partial-height silicon region 419 extends around an outside wall of the rib ring 407. The rib ring 407 itself surrounds a partial-height (partial-thickness) silicon region 417. More specifically, the partial-height silicon region 417 extends around an inside wall of the rib ring 407. The optical waveguide 413 is bracketed by the partial-height (partial-thickness) silicon region 419 on a side of the optical waveguide 413 that faces toward the ring modulator 400, and is bracketed by a partial-height (partial-thickness) silicon region 421 on a side of the optical waveguide 413 that faces away from the ring modulator 400. The partial-height silicon region 419 also extends between the rib ring 407 and the optical waveguide 413. The optical waveguide 463 is bracketed by the partial-height (partial-thickness) silicon region 419 on a side of the optical waveguide 463 that faces toward the ring modulator 400, and is bracketed by a partial-height (partial-thickness) silicon region 471 on a side of the optical waveguide 463 that faces away from the ring modulator 400. The partial-height silicon region 419 also extends between the rib ring 407 and the optical waveguide 463.

A full-height (full-thickness) silicon region 405 extends along an outer radial periphery of a portion of the partial-height silicon region 419 that extends along an azimuthal angular span 428 about a center 440 of the ring modulator 400 radially outside of the rib ring 407. A full-height (full-thickness) silicon region 406 extends along an outer radial periphery of a portion of the partial-height silicon region 419 that extends along an azimuthal angular span 430 about the center 440 of the ring modulator 400 radially outside of the rib ring 407. A full-height (full-thickness) silicon region 416 extends along the partial-height silicon region 419 on a side of the partial-height silicon region 419 that is located away from the optical waveguide 413. A full-height (full-thickness) silicon region 415 extends along the partial-height silicon region 421 on a side of the partial-height silicon region 421 that is located away from the optical waveguide 413. A full-height (full-thickness) silicon region 418 extends along the partial-height silicon region 419 on a side of the partial-height silicon region 419 that is located away from the optical waveguide 463. A full-height (full-thickness) silicon region 475 extends along the partial-height silicon region 471 on a side of the partial-height silicon region 471 that is located away from the optical waveguide 463. Full-height (full-thickness) silicon regions 409, 410, 411, and 412 are formed along an inner side of the partial-height silicon region 417 that is located away from the rib ring 407.

The ring modulator 400 is formed within an optical cladding material 403 that includes an inner optical cladding material 403I, a first outer optical cladding material 403O1, second outer optical cladding material 403O2, and a third outer optical cladding material 403O3. More specifically, in some embodiments, the inner optical cladding material 403I is circumscribed by a combination of the full-height (full-thickness) silicon regions 409, 410, 411, and 412 and the partial-height silicon region 417. The first outer optical cladding material 403O1 is present along a side of the full-height (full-thickness) silicon region 475 that is located away from the ring modulator 400. The second outer optical cladding material 403O2 is present outside of the ring modulator 400 and between the full-height (full-thickness) silicon regions 416 and 418. The third outer optical cladding material 403O3 is present along a side of the full-height (full-thickness) silicon region 415 that is located away from the ring modulator 400.

A number of inner electrical contacts 423 (shown as black dots) are formed in electrical connection with the full-height (full-thickness) silicon region 409 along the inner side of the partial-height silicon region 417 that is located away from the rib ring 407. A number of inner electrical contacts 423 (shown as black dots) are formed in electrical connection with the full-height (full-thickness) silicon region 410 along the inner side of the partial-height silicon region 417 that is located away from the rib ring 407. Also, a number of inner electrical contacts 424 (shown as black dots) are formed in electrical connection with the full-height (full-thickness) silicon regions 411, respectively, along the inner side of the partial-height silicon region 417 that is located away from the rib ring 407. Also, a number of inner electrical contacts 426 (shown as black dots) are formed in electrical connection with the full-height (full-thickness) silicon regions 412, respectively, along the inner side of the partial-height silicon region 417 that is located away from the rib ring 407. Also, a number outer electrical contacts 425 (shown as black dots) are formed in electrical connection with the full-height (full-thickness) silicon region 405 that extends along the outer radial periphery of the portion of the partial-height silicon region 419 that extends radially around the rib ring 407. Also, a number outer electrical contacts 425 (shown as black dots) are formed in electrical connection with the full-height (full-thickness) silicon region 406 that extends along the outer radial periphery of the portion of the partial-height silicon region 419 that extends radially around the rib ring 407.

The ring modulator 400 has an N-type doping region 427R that includes portions of the rib ring 407, portions of the partial-height silicon region 417, and the full-height (full-thickness) silicon region 409. The ring modulator 400 also has an N-type doping region 427L that includes portions of the rib ring 407, portions of the partial-height silicon region 417, and the full-height (full-thickness) silicon region 410. The ring modulator 400 also has a number of tab-shaped N-type doping regions 427T that each project inward from the rib ring 407 toward the center 440 of the ring modulator 400 to form respective portions of the interdigitated diode configuration within the optical coupling region 420. Each of the tab-shaped N-type doping regions 427T within the optical coupling region 420 includes a corresponding portion of the rib ring 407, a corresponding portion of the partial-height silicon region 417, and a corresponding one of the full-height (full-thickness) silicon regions 411. Similarly, the ring modulator 400 has a number of tab-shaped N-type doping regions 427T that each project inward from the rib ring 407 toward the center 440 of the ring modulator 400 to form respective portions of the interdigitated diode configuration within the optical coupling region 470. Each of the tab-shaped N-type doping regions 427T within the optical coupling region 470 includes a corresponding portion of the rib ring 407, a corresponding portion of the partial-height silicon region 417, and a corresponding one of the full-height (full-thickness) silicon regions 412.

The ring modulator 400 has a P-type doping region 429R that includes portions of the rib ring 407, portions of the partial-height silicon region 419, and the full-height (full-thickness) silicon region 405. The ring modulator 400 also has a P-type doping region 429L that includes portions of the rib ring 407, portions of the partial-height silicon region 419, and the full-height (full-thickness) silicon region 406. The ring modulator 400 also has a number of tab-shaped P-type doping regions 429T that each project inward from the rib ring 407 toward the center 440 of the ring modulator 400 to form respective portions of the interdigitated diode configuration within the optical coupling region 420. Each of the tab-shaped P-type doping regions 429T within the optical coupling region 420 includes a corresponding portion of the rib ring 407, a corresponding portion of the partial-height silicon region 417, and a corresponding one of the full-height (full-thickness) silicon regions 411. Similarly, the ring modulator 400 has a number of tab-shaped P-type doping regions 429T that each project inward from the rib ring 407 toward the center 440 of the ring modulator 400 to form respective portions of the interdigitated diode configuration within the optical coupling region 470. Each of the tab-shaped N-type doping regions 429T within the optical coupling region 470 includes a corresponding portion of the rib ring 407, a corresponding portion of the partial-height silicon region 417, and a corresponding one of the full-height (full-thickness) silicon regions 412.

The tab-shaped N-type doping regions 427T and the tab-shaped P-type doping regions 429T alternate in placement with respect to each other along the curvature of the rib ring 407 within the optical coupling region 420. In this manner, the tab-shaped N-type doping regions 427T and the tab-shaped P-type doping regions 429T collectively form the interdigitated diode configuration within the optical coupling region 420. Also, the tab-shaped N-type doping regions 427T and the tab-shaped P-type doping regions 429T alternate in placement with respect to each other along the curvature of the rib ring 407 within the optical coupling region 470. In this manner, the tab-shaped N-type doping regions 427T and the tab-shaped P-type doping regions 429T collectively form the interdigitated diode configuration within the optical coupling region 470. In some embodiments, adjacently positioned ones of the tab-shaped N-type doping regions 427T and the tab-shaped P-type doping regions 429T are separated from each other by a non-doped portion of the partial-height silicon region 417.

The N-type doping regions 427T and the P-type doping region 429T interface with each other within the rib ring 407 to form a portion of a PN junction diode within the optical coupling region 420. Similarly, the N-type doping regions 427T and the P-type doping region 429T interface with each other within the rib ring 407 to form a portion of the PN junction diode within the optical coupling region 470. Also, the N-type doping regions 427R and the P-type doping region 429R interface with each other within the rib ring 407 to form a portion of the PN junction diode. Similarly, the N-type doping regions 427L and the P-type doping region 429L interface with each other within the rib ring 407 to form a portion of the PN junction diode. The tab-shaped N-type doping regions 427T and the tab-shaped P-type doping regions 429T within the optical coupling region 420 provide respective electrically conductive pathways from the PN junction diode within the rib ring 407 to respective ones of the inner electrical contacts 424. In this manner, the N-type doping regions 427T of the PN junction diode within the rib ring 407, within the optical coupling region 420, are electrically connected to a first node of an electrical circuit through corresponding inner electrical contacts 424. Also, the P-type doping regions 429T of the PN junction diode within the rib ring 407, within the optical coupling region 420, are electrically connected to a second node of an electrical circuit through corresponding inner electrical contacts 424. Additionally, the tab-shaped N-type doping regions 427T and the tab-shaped P-type doping regions 429T within the optical coupling region 470 provide respective electrically conductive pathways from the PN junction diode within the rib ring 407 to respective ones of the inner electrical contacts 426. In this manner, the N-type doping regions 427T of the PN junction diode within the rib ring 407, within the optical coupling region 470, are electrically connected to the first node of the electrical circuit through corresponding inner electrical contacts 426. Also, the P-type doping regions 429T of the PN junction diode within the rib ring 407, within the optical coupling region 470, are electrically connected to the second node of the electrical circuit through corresponding inner electrical contacts 426.

In the ring modulator 400, the PN junction diode formed within the rib ring 407 extends through the optical coupling region 420 as indicated by arrow 422. Also, the PN junction diode formed within the rib ring 407 extends from the optical coupling region 420 to the optical coupling region 470 as indicated by arrow 428. Also, the PN junction diode formed within the rib ring 407 extends through the optical coupling region 470 as indicated by arrow 472. Also, the PN junction diode formed within the rib ring 407 extends from the optical coupling region 470 to the optical coupling region 420 as indicated by arrow 430. Additionally, in some embodiments, such as shown in FIG. 4A, the PN junction diode interface within the rib ring 407 between the N-type doping region 427R and the P-type doping region 429R is formed in a serpentine configuration 443, e.g., gear-tooth-shaped configuration, in order to increase the overall interface area of the PN junction diode within the rib ring 407. Also, in some embodiments, such as shown in FIG. 4A, the PN junction diode interface within the rib ring 407 between the N-type doping region 427L and the P-type doping region 429L is formed in a serpentine configuration 445, e.g., gear-tooth-shaped configuration, in order to increase the overall interface area of the PN junction diode within the rib ring 407.

FIGS. 4B through 4G show a succession of fabrication processes performed to arrive at the example ring modulator 400 of FIG. 4A, in accordance with some embodiments. FIG. 4B shows a top view of a configuration of full-height (full-thickness) silicon 401 formed within the cladding material 403, in accordance with some embodiments. A portion of the configuration of full-height (full-thickness) silicon 401 is used to form the ring modulator 400. Another portion of the configuration of full-height (full-thickness) silicon 401 is used to form the optical waveguides 413 and 463 that extend past the ring modulator 400.

FIG. 4C shows a top view of the configuration of full-height (full-thickness) silicon 401 with portions of the full-height (full-thickness) silicon 401 etched away to form the partial-height (partial-thickness) silicon regions 417, 419, 421, and 471, in accordance with some embodiments. The thickness of the partial-height (partial-thickness) silicon regions 417, 419, 421, and 471 is less than the thickness of the full-height (full-thickness) silicon 401. The partial-height (partial-thickness) silicon regions 417, 419, 421, and 471 are configured and positioned such that a first remaining portion of the full-height (full-thickness) silicon 401 forms the rib ring 407, and such that a second remaining portion of the full-height (full-thickness) silicon 401 forms the outer silicon regions 405 and 406, and such that a third remaining portion of the full-height (full-thickness) silicon 401 forms the inner silicon regions 409, 410, 411, and 412, and such that a fourth remaining portion of the full-height (full-thickness) silicon 401 forms the optical waveguide 413, and such that a fifth remaining portion of the full-height (full-thickness) silicon 401 forms the full-height (full-thickness) silicon region 416, and such that a sixth remaining portion of the full-height (full-thickness) silicon 401 forms the full-height (full-thickness) silicon region 415, and such that a seventh remaining portion of the full-height (full-thickness) silicon 401 forms the optical waveguide 463, and such that a eighth remaining portion of the full-height (full-thickness) silicon 401 forms the full-height (full-thickness) silicon region 418, and such that a ninth remaining portion of the full-height (full-thickness) silicon 401 forms the full-height (full-thickness) silicon region 475.

FIG. 4D shows a top view of the partially formed ring modulator 400 of FIG. 4C with formation of the inner electrical contacts 423, the inner electrical contacts 424, the inner electrical contacts 426, and the outer electrical contacts 425, in accordance with some embodiments. The inner electrical contacts 423 are formed in electrical connection with the inner full-height (full-thickness) silicon regions 409 and 410. The inner electrical contacts 424 are formed in electrical connection with the inner full-height (full-thickness) silicon regions 411, respectively. The inner electrical contacts 426 are formed in electrical connection with the inner full-height (full-thickness) silicon regions 412, respectively. The outer electrical contacts 425 are formed in electrical connection with the outer full-height (full-thickness) silicon regions 405 and 406. In some embodiments, the inner electrical contacts 423 are substantially uniformly azimuthally spaced about the center 440 of the ring modulator 400 along each of the inner full-height (full-thickness) silicon regions 409 and 410. In some embodiments, the outer electrical contacts 425 are substantially uniformly azimuthally spaced about the center 440 of the ring modulator 400 along each of the outer full-height (full-thickness) silicon regions 405 and 406.

FIG. 4E shows a top view of the partially formed ring modulator 400 of FIG. 4D with formation of the N-type doping regions 427L and 427R, and the tab-shaped N-type doping regions 427T, in accordance with some embodiments. The N-type doping region 427R is formed within the silicon of the inner full-height (full-thickness) silicon region 409, and within the partial-height (partial-thickness) silicon region 417 that extends along the inner full-height (full-thickness) silicon region 409, and within an adjoining portion of the rib ring 407. The N-type doping region 427R is electrically connected to the inner electrical contacts 423 by way of the inner full-height (full-thickness) silicon region 409. The N-type doping region 427L is formed within the silicon of the inner full-height (full-thickness) silicon region 410, and within the partial-height (partial-thickness) silicon region 417 that extends along the inner full-height (full-thickness) silicon region 410, and within an adjoining portion of the rib ring 407. The N-type doping region 427L is electrically connected to the inner electrical contacts 423 by way of the inner full-height (full-thickness) silicon region 410. The tab-shaped N-type doping regions 427T are formed within the optical coupling region 420, such that each of the tab-shaped N-type doping regions 427T includes a respective portion of the rib ring 407, and extends inward across the partial-height (partial-thickness) silicon region 417 toward the center 440 of the ring modulator 400, and includes a corresponding one of the full-height (full-thickness) silicon regions 411, so as to electrically connect with a corresponding one of the inner electrical contacts 424. The tab-shaped N-type doping regions 427T are also formed within the optical coupling region 470, such that each of the tab-shaped N-type doping regions 427T includes a respective portion of the rib ring 407, and extends inward across the partial-height (partial-thickness) silicon region 417 toward the center 440 of the ring modulator 400, and includes a corresponding one of the full-height (full-thickness) silicon regions 412, so as to electrically connect with a corresponding one of the inner electrical contacts 426.

FIG. 4F shows the top view of the ring modulator 400 of FIG. 4E with formation of the P-type doping regions 429L and 429R, and the tab-shaped P-type doping regions 429T, in accordance with some embodiments. The P-type doping region 429R is formed within the silicon of the outer full-height (full-thickness) silicon region 405, and within the partial-height (partial-thickness) silicon region 419 that extends along the outer full-height (full-thickness) silicon region 405, and within an adjoining portion of the rib ring 407. The P-type doping region 429R is electrically connected to the outer electrical contacts 425 by way of the outer full-height (full-thickness) silicon region 405. The P-type doping region 429L is formed within the silicon of the outer full-height (full-thickness) silicon region 406, and within the partial-height (partial-thickness) silicon region 419 that extends along the outer full-height (full-thickness) silicon region 406, and within an adjoining portion of the rib ring 407. The P-type doping region 429L is electrically connected to the outer electrical contacts 425 by way of the outer full-height (full-thickness) silicon region 406. The tab-shaped P-type doping regions 429T are formed within the optical coupling region 420, such that each of the tab-shaped P-type doping regions 429T includes a respective portion of the rib ring 407, and extends inward across the partial-height (partial-thickness) silicon region 417 toward the center 440 of the ring modulator 400, and includes a corresponding one of the full-height (full-thickness) silicon regions 411, so as to electrically connect with a corresponding one of the inner electrical contacts 424. The tab-shaped P-type doping regions 429T are also formed within the optical coupling region 470, such that each of the tab-shaped P-type doping regions 429T includes a respective portion of the rib ring 407, and extends inward across the partial-height (partial-thickness) silicon region 417 toward the center 440 of the ring modulator 400, and includes a corresponding one of the full-height (full-thickness) silicon regions 412, so as to electrically connect with a corresponding one of the inner electrical contacts 426. The tab-shaped P-type doping regions 429T and the P-type doping regions 429L and 429R are integrally formed with each other, so as to be electrically connected to each other. In some embodiments, such as shown in FIG. 4F, adjacently formed ones of the tab-shaped P-type doping regions 429T and the tab-shaped N-type doping regions 427T are interfaced with each other within the rib ring 407 to form the PN junction diode interface within the rib ring 407, but are spaced apart from each other over the partial-height (partial-thickness) silicon region 417 and over the full-height (full-thickness) silicon regions 411 and 412, so as to form separate electrical conduction pathways.

FIG. 4G shows a top view of the ring modulator 400 of FIG. 4F with the N-type doping regions 427L and 427R, and the tab-shaped N-type doping regions 427T electrically connected to a first electrical node by way of an electrical conductor 481, in accordance with some embodiments. The electrical conductor 481 is electrically connected to the inner electrical contacts 423, 424, and 426 that are electrically connected to one of N-type doping regions 427R, 427L, and 427T. FIG. 4G also shows the P-type doping regions 429L and 429R, and the tab-shaped P-type doping regions 429T electrically connected to a second electrical node by way of an electrical conductor 483. The electrical conductor 483 is electrically connected to the inner electrical contacts 424 and 426 that are electrically connected to one of N-type doping regions 429T. Also, the electrical conductor 483 is electrically connected to the outer electrical contacts 425.

Each of the P-type doping regions 429L and 429R, the tab-shaped P-type doping regions 429T, the N-type doping regions 427L and 427R, and the tab-shaped N-type doping regions 427T is doped with impurity ions to form the lateral PN junction diode. In some embodiments, the P-type doping regions 429L and 429R and tab-shaped P-type doping regions 429T are doped with acceptor impurity atoms, and the N-type doping regions 427L and 427R and the tab-shaped N-type doping regions 427T are doped with donor impurity atoms. In this manner, the N-type doping regions 427L, 427R, 427T and the P-type doping regions 429L, 429R, 429T are doped with opposite polarity. The interface between the N-type doping regions 427L, 427R, 427T and the P-type doping regions 429L, 429R, 429T within the rib ring 407 is the PN junction of the lateral PN junction diode. At the PN junction within the rib ring 407, the free electrons diffuse into the P-type doping regions 429L, 429R, 429T, and the holes (electron vacancies) diffuse into the N-type doping regions 427L, 427R, 427T, which causes a depletion region to form along the PN junction within the rib ring 407. It should be appreciated that in the ring modulator 400, the PN junction diode formed by the P-type doping regions 429L, 429R, 429T, and the N-type doping region 427L, 427R, 427T extends through both the optical coupling region 420 and the optical coupling region 470. Within the optical coupling region 420, the tab-shaped N-type doping regions 427T formed within the partial-height (partial-thickness) silicon region 417 provide respective electrically conductive paths between the inner electrical contacts 424 and the depletion region formed along the PN junction within the rib ring 407. Also, within the optical coupling region 420, the tab-shaped P-type doping regions 427T formed within the partial-height (partial-thickness) silicon region 417 provide respective electrically conductive paths between the inner electrical contacts 424 and the depletion region formed along the PN junction within the rib ring 407. Within the optical coupling region 470, the tab-shaped N-type doping regions 427T formed within the partial-height (partial-thickness) silicon region 417 provide respective electrically conductive paths between the inner electrical contacts 426 and the depletion region formed along the PN junction within the rib ring 407. Also, within the optical coupling region 470, the tab-shaped P-type doping regions 429T formed within the partial-height (partial-thickness) silicon region 417 provide respective electrically conductive paths between the inner electrical contacts 426 and the depletion region formed along the PN junction within the rib ring 407. Along the rib ring 407 between the optical coupling region 420 and the optical coupling region 470, the N-type doping regions 427L and 427R formed within the partial-height (partial-thickness) silicon region 417 provide electrically conductive paths between the inner electrical contacts 423 and the depletion region formed along the PN junction within the rib ring 407. Also, along the rib ring 407 between of the optical coupling region 420 and the optical coupling region 470, the P-type doping regions 429L and 429R formed within the partial-height (partial-thickness) silicon region 419 provide electrically conductive paths between the outer electrical contacts 425 and the depletion region formed along the PN junction within the rib ring 407.

In some embodiments, with the lateral PN junction diode within the rib ring 407 electrically connected in a reverse-biased manner to an electrical voltage source, the inner electrical contacts 423 of the N-type doping regions 427L and 427R and the inner electrical contacts 424 and 426 of the tab-shaped N-type doping regions 427T are electrically connected to the anode of the electrical voltage source. Also, in some embodiments, with the lateral PN junction diode within the rib ring 407 electrically connected in a reverse-biased manner to the electrical voltage source, the outer electrical contacts 425 of the P-type doping regions 429L and 429R and the inner electrical contacts 424 and 426 of the tab-shaped P-type doping regions 429T are electrically connected to the cathode of the electrical voltage source. The outer electrical contacts 425 are positioned far enough from the rib ring 407 to reduce optical absorption of the light traveling through the rib ring 407 by metal and silicided regions that form the outer electrical contacts 425. Also, the inner electrical contacts 424 and 426 are positioned far enough from the rib ring 407 to reduce optical absorption of the light traveling through the rib ring 407 by metal and silicided regions that form the inner electrical contacts 424 and 326.

In the ring modulator 400, the lateral PN junction diode extends into the optical coupling region 420 of the ring modulator 400 without adversely affecting optical absorption loss in the optical waveguide 413 to which the ring modulator 400 is optically coupled. Also, positioning of the tab-shaped N-type doping regions 427T and the tab-shaped P-type doping regions 429T on the inside of the rib ring 407 so as to extend toward the center 440 of ring modulator 400 enables the lateral PN junction diode to extend through the optical coupling region 420 of the ring modulator 400 without adversely affecting optical absorption loss in the optical waveguide 413 to which the ring modulator 400 is optically coupled. Additionally, by having the multiple tab-shaped N-type doping regions 427T and tab-shaped P-type doping regions 429T alternatively positioned along the arc of the rib ring 407 within the optical coupling region 420, the electrical series resistance in the lateral PN junction diode of the ring modulator 400 is not adversely increased by having the lateral PN junction diode extend through the optical coupling region 420.

In the ring modulator 400, the lateral PN junction diode extends into the optical coupling region 470 of the ring modulator 400 without adversely affecting optical absorption loss in the optical waveguide 463 to which the ring modulator 400 is optically coupled. Also, positioning of the tab-shaped N-type doping regions 427T and the tab-shaped P-type doping regions 429T on the inside of the rib ring 407 so as to extend toward the center 440 of ring modulator 400 enables the lateral PN junction diode to extend through the optical coupling region 470 of the ring modulator 400 without adversely affecting optical absorption loss in the optical waveguide 463 to which the ring modulator 400 is optically coupled. Additionally, by having the multiple tab-shaped N-type doping regions 427T and tab-shaped P-type doping regions 429T alternatively positioned along the arc of the rib ring 407 within the optical coupling region 470, the electrical series resistance in the lateral PN junction diode of the ring modulator 400 is not adversely increased by having the lateral PN junction diode extend through the optical coupling region 470.

The ring modulator 400 uses the interdigitated PN junction diode design (interdigitation of the tab-shaped N-type doping regions 427T and the tab-shaped P-type doping regions 429T) in the portions of the rib ring 407 that pass through each of the optical coupling regions 420 and 470, while using a different non-interdigitated PN junction diode design in the portion of the rib ring 407 that does not pass through the optical coupling regions 420 or 470. Within the optical coupling region 420, the inner electrical contacts 424 are positioned along the inner region of the ring modulator 400, far from the rib ring 407 and even farther from the optical waveguide 413, so as to avoid optical absorption loss in the coupling optical waveguides 407 and 413. Similarly, within the optical coupling region 470, the inner electrical contacts 426 are positioned along the inner region of the ring modulator 400, far from the rib ring 407 and even farther from the optical waveguide 463, so as to avoid optical absorption loss in the coupling optical waveguides 407 and 463. The interdigitated tab-shaped N-type doping regions 427T and tab-shaped P-type doping regions 429T alternate polarity (alternate cathode and anode) within each of the optical coupling regions 420 and 470. It should be understood that there is more flexibility in the design of the portions of the ring modulator 400 that are away from the optical coupling regions 420 and 470. For example, in the regions of the ring modulator 400 away from the optical coupling regions 420 and 470, the inner electrical contacts 423 and the N-type doping regions 427L and 427R are placed on the inner side of the rib ring 407, and the outer electrical contacts 425 and the P-type doping regions 429L and 429R are placed on the outer side of the rib ring 407, so as to reduce and/or minimize the series electrical resistance of the ring modulator 400. All of the inner electrical contacts 423 that are electrically connected to the N-type doping regions 427L and 427R and all of the inner electrical contacts 424 and 426 that are connected to a corresponding one of the tab-shaped N-type doping regions 427T are collectively electrically connected to a same first electrical node. Similarly, all of the outer electrical contacts 425 that are electrically connected to the P-type doping regions 429L and 429R and all of the inner electrical contacts 424 and 426 that are connected to a corresponding one of the tab-shaped P-type doping regions 429T are collectively electrically connected to a same second electrical node that is different and electrically separated from the first electrical node. In various embodiments, electrically conductive structures, e.g., metal traces/wires, and electrically conductive via structures are formed in and/or through different levels of the semiconductor device in which the ring modulator 400 is formed in order to electrically connect all of the inner electrical contacts 423 that are electrically connected to the N-type doping regions 427L and 427R and all of the inner electrical contacts 424 and 426 that are connected to a corresponding one of the tab-shaped N-type doping regions 427T to the same first electrical node, such as exemplified by the electrical conductor 481. In various embodiments, electrically conductive structures, e.g., metal traces/wires, and electrically conductive via structures are formed in and/or through different levels of the semiconductor device in which the ring modulator 400 is formed in order to electrically connect all of the outer electrical contacts 425 that are electrically connected to the P-type doping regions 429L and 429R and all of the inner electrical contacts 424 and 426 that are connected to a corresponding one of the tab-shaped P-type doping regions 429T to the same second electrical node, such as exemplified by the electrical conductor 483.

In accordance with the foregoing, the ring resonator 400 includes a built-in diode for modulating an optical signal propagating through the optical waveguide 413 and/or the optical waveguide 463. The optical mode supported by the ring resonator 400 has significant power density that overlaps the depletion region of the PN junction diode within the rib ring 407. By changing the voltage differential between the anode and cathode of the PN junction diode within the rib ring 407, charge carriers can be added to or removed from the depletion region of the PN junction within the rib ring 407 in a controlled manner, which provides for changing of the refractive index and optical absorption coefficient of the rib ring 407 in a controlled manner by way of the plasma effect, which in turn provides for controlled changing of the amplitude and phase of the light that is transmitted on through the optical waveguide 413 and/or the optical waveguide 463 past the ring modulator 400. In some embodiments, the PN junction diode within the rib ring 407 of the ring modulator 400 is operated in a reversed bias manner to enable fast charge transport and correspondingly high optical modulation data rates.

In some embodiments, the optical waveguide 413 and/or the optical waveguide 463 carries multiple wavelength channels of light, with only one of the multiple wavelength channels of light being coupled into and modulated by the ring resonator 400. In some embodiments, such as in WDM systems, multiple instances of the ring resonator 400 are optically coupled to the same optical waveguide 413 and/or the optical waveguide 463, with each of the ring resonators 400 tuned to modulate a different one of the multiple wavelength channels of light propagating through the optical waveguide 413 and/or the optical waveguide 463. The metal of the inner electrical contacts 424 and 426 absorbs light across all wavelengths. Therefore, by having the inner electrical contacts 424 and 426 positioned away from the optical waveguides 413 and 463, respectively, e.g., by a distance greater than or equal to about one micrometer, within each instance of the ring modulator 400, it is possible to avoid introduction and accumulation of excess absorption loss of the light propagating through the optical waveguides 413 and 463, respectively, across every wavelength channel of light.

In some embodiments, either the optical waveguide 413 or the optical waveguide 463 is utilized as a drop port optical waveguide to tap off a small fraction of the optical power in the ring modulator 400 into a separate photodiode (photodetector) in order to monitor the optical power within the ring modulator 400. It should be appreciated that the electrical contacts 424 and 426 and associated wiring are positioned so as to avoid introducing adverse optical absorption loss into the optical waveguide 413 or 463 that is being utilized as the drop port optical waveguide, which allows for sufficient optical power to reach the photodiode to enable monitoring of optical power within the ring modulator 400.

It should be appreciated that the ring modulator 400 configuration is particularly important for applications in which the wavelength spacing requires ring modulators with relatively high free spectral range (FSR), for which the ring modulator must have a relatively small radius. In such applications the fractional angle of the optical coupling region 420 and/or 470 may be as much as half the angular region of the ring modulator 400. The interdigitated PN junction diode design of the ring modulator 400 provides for acceptable modulation efficiency even when such large angular spans are required for the optical absorption region 420 and/or 470 due to the ring modulator 400 having a relatively small radius, because the interdigitated PN junction diode extends through the optical absorption region 420 and/or 470.

FIG. 4H shows a top view of the ring modulator 400 with the doped-silicon non-silicided resistive radial-current heater 300 of FIG. 3 disposed inside of the ring modulator 400, in accordance with some embodiments. More specifically, the doped-silicon non-silicided resistive radial-current heater 300 is disposed within the region circumscribed by the combination of the full-height (full-thickness) silicon regions 409, 410, 411, and 412 and the partial-height silicon region 417 of the ring modulator 400. The silicon of the doped-silicon non-silicided resistive radial-current heater 300 displaces the inner optical cladding material 403I. In some embodiments, an oxide region 490 radially separates the silicon of the doped-silicon non-silicided resistive radial-current heater 300 from the silicon of the ring modulator 400.

FIG. 4I shows a close-up view of a region 492, as referenced in FIG. 4H, of the doped-silicon non-silicided resistive radial-current heater 300 within the ring modulator 400, in accordance with some embodiments. The oxide region 490 creates a thermal resistance which limits the flow of heat from the doped-silicon non-silicided resistive radial-current heater 300 to the rib ring 407, so that the flow of heat is kept as small as possible given the constraints of the process, manufacturability, etc. In some embodiments, a radial thickness 490A of the oxide region 490 is within a range greater than zero and up to about 200 nanometers (nm). In some embodiments, the radial thickness 490A of the oxide region 490 is within a range greater than zero and up to about 150 nm. Also, in some embodiments, the doped-silicon non-silicided resistive radial-current heater 300 has an outer diameter within a range extending from about 4 μm to about 5 μm.

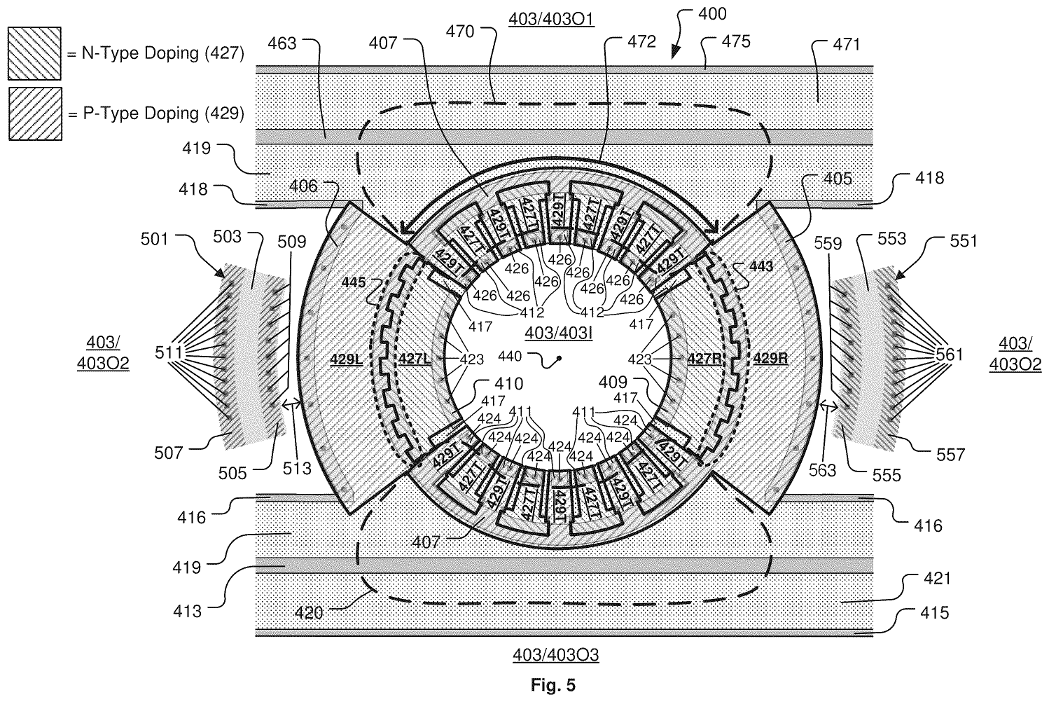

FIG. 5 shows the top view of the ring modulator 400 of FIG. 4A implementing a first doped-silicon non-silicided resistive heater 501 and a second doped-silicon non-silicided resistive heater 551 outside of the rib ring 407, in accordance with some embodiments. The first doped-silicon non-silicided resistive heater 501 includes a doped-silicon non-silicided region 503, an inner contact region 505, and an outer contact region 507. Each of the inner contact region 505 and the outer contact region 507 is formed of electrically conductive silicided silicon. The doped-silicon non-silicided region 503 has a greater electrical resistance than each of the inner contact region 505 and the outer contact region 507. A first plurality of electrical contacts 509 are electrically connected to the inner contact region 505. A second plurality of electrical contacts 511 are electrically connected to the outer contact region 507. In some embodiments, the first plurality of electrical contacts 509 and the second plurality of electrical contacts 511 are formed as electrically conductive via structures. The doped-silicon non-silicided region 503 is electrically connected to both the inner contact region 505 and the outer contact region 507. In some embodiments, the doped-silicon non-silicided region 503, the inner contact region 505, and the outer contact region 507 are formed as respective portions of a same silicon structure. A first voltage is applied to the inner contact region 505 by way of the first plurality of electrical contacts 509. A second voltage is applied to the outer contact region 507 by way of the second plurality of electrical contacts 511. A voltage difference between the first voltage and the second voltage is controlled to cause a controlled flow of electrical current through the doped-silicon non-silicided region 503 between the inner contact region 505 and the outer contact region 507, which causes a controlled amount of heat generation within the doped-silicon non-silicided region 503. The inner contact region 505 is separated from the silicon region 406 of the ring modulator 400 by an oxide region, as indicated by arrow 513. In various embodiments, the oxide region, as indicated by arrow 513, is sized to ensure that the doped-silicon non-silicided region 503 is in thermal communication with the rib ring 407.

The doping level of the doped-silicon non-silicided region 503 is set to achieve a target sheet electrical resistance. In some embodiments, the target sheet electrical resistance of the doped-silicon non-silicided region 503 is within a range extending from about 70 ohms to about 250 ohms. In some embodiments, the target sheet electrical resistance of the doped-silicon non-silicided region 503 is within a range extending from about 100 ohms to about 200 ohms. In some embodiments, the target sheet electrical resistance of the doped-silicon non-silicided region 503 is within a range extending from about 1000 ohms per μm² to about 8000 ohms per μm². In some embodiments, the target sheet electrical resistance of the doped-silicon non-silicided region 503 is within a range extending from about 2000 ohms per μm² to about 5000 ohms per μm².

The second doped-silicon non-silicided resistive heater 551 includes a doped-silicon non-silicided region 553, an inner contact region 555, and an outer contact region 557. Each of the inner contact region 555 and the outer contact region 557 is formed of electrically conductive silicided silicon. The doped-silicon non-silicided region 553 has a greater electrical resistance than each of the inner contact region 555 and the outer contact region 557. A first plurality of electrical contacts 559 are electrically connected to the inner contact region 555. A second plurality of electrical contacts 561 are electrically connected to the outer contact region 557. In some embodiments, the first plurality of electrical contacts 559 and the second plurality of electrical contacts 561 are formed as electrically conductive via structures. The doped-silicon non-silicided region 553 is electrically connected to both the inner contact region 555 and the outer contact region 557. In some embodiments, the doped-silicon non-silicided region 553, the inner contact region 555, and the outer contact region 557 are formed as respective portions of a same silicon structure. A first voltage is applied to the inner contact region 555 by way of the first plurality of electrical contacts 559. A second voltage is applied to the outer contact region 557 by way of the second plurality of electrical contacts 561. A voltage difference between the first voltage and the second voltage is controlled to cause a controlled flow of electrical current through the doped-silicon non-silicided region 553 between the inner contact region 555 and the outer contact region 557, which causes a controlled amount of heat generation within the doped-silicon non-silicided region 553. The inner contact region 555 is separated from the silicon region 405 of the ring modulator 400 by an oxide region, as indicated by arrow 563 In various embodiments, the oxide region, as indicated by arrow 563, is sized to ensure that the doped-silicon non-silicided region 553 is in thermal communication with the rib ring 407.

The doping level of the doped-silicon non-silicided region 553 is set to achieve a target sheet electrical resistance. In some embodiments, the target sheet electrical resistance of the doped-silicon non-silicided region 553 is within a range extending from about 70 ohms to about 250 ohms. In some embodiments, the target sheet electrical resistance of the doped-silicon non-silicided region 553 is within a range extending from about 100 ohms to about 200 ohms. In some embodiments, the target sheet electrical resistance of the doped-silicon non-silicided region 553 is within a range extending from about 1000 ohms per μm² to about 8000 ohms per μm². In some embodiments, the target sheet electrical resistance of the doped-silicon non-silicided region 553 is within a range extending from about 2000 ohms per μm² to about 5000 ohms per μm². In some embodiments, the electro-optical semiconductor chip includes just one of the first doped-silicon non-silicided resistive heater 501 and the second doped-silicon non-silicided resistive heater 551 formed in conjunction with the ring modulator 400. In some embodiments, the electro-optical semiconductor chip includes both of the first doped-silicon non-silicided resistive heater 501 and the second doped-silicon non-silicided resistive heater 551 formed in conjunction with the ring modulator 400.

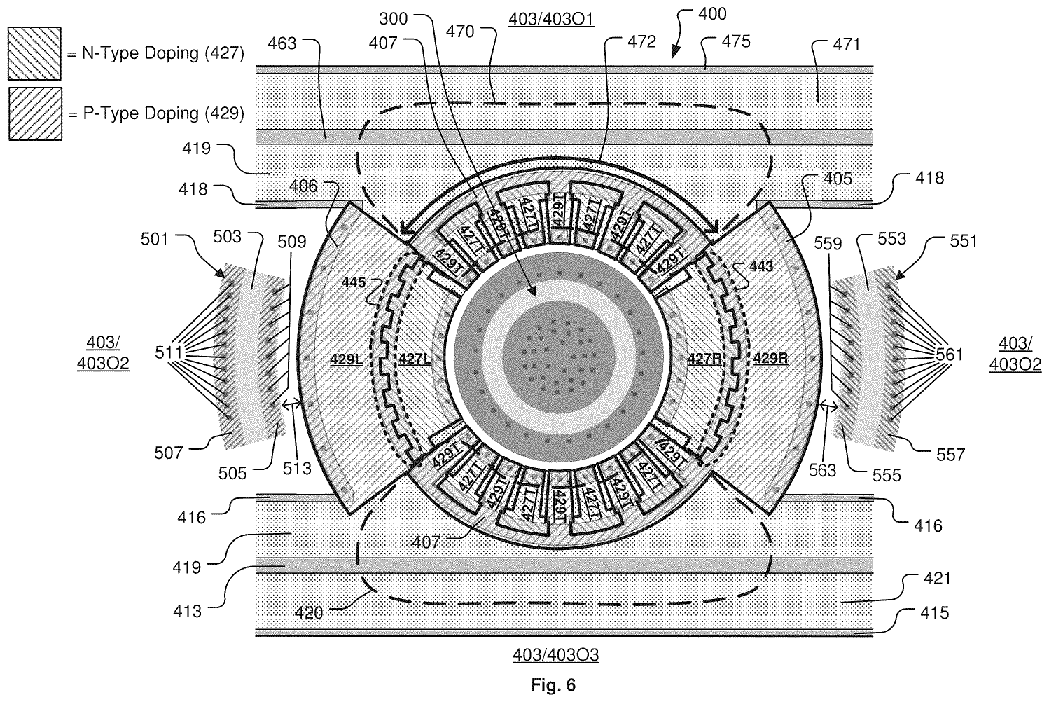

FIG. 6 shows a top view of the ring modulator 400 of FIG. 4A implementing each of the first doped-silicon non-silicided resistive heater 501 outside of the rib ring 407, the second doped-silicon non-silicided resistive heater 551 outside of the rib ring 407, and the doped-silicon non-silicided resistive radial-current heater 300 of FIG. 3 inside of the ring modulator 400, in accordance with some embodiments. It should be understood that in various embodiments, any one or more of the first doped-silicon non-silicided resistive heater 501, the second doped-silicon non-silicided resistive heater 551, and the doped-silicon non-silicided resistive radial-current heater 300 can be implemented with a ring modulator or ring resonator structure, such as the ring modulator 400 by way of example.

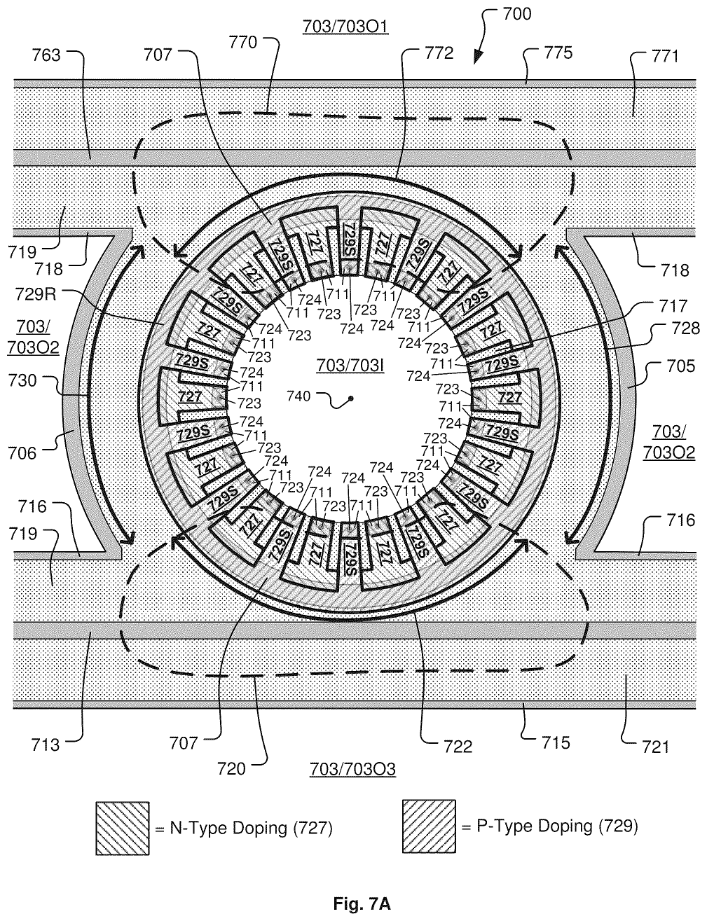

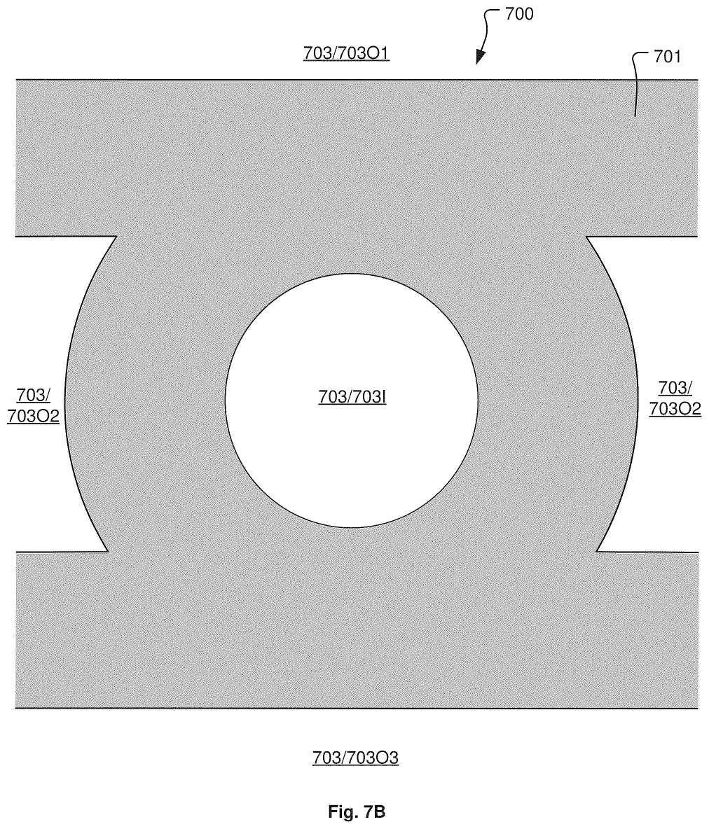

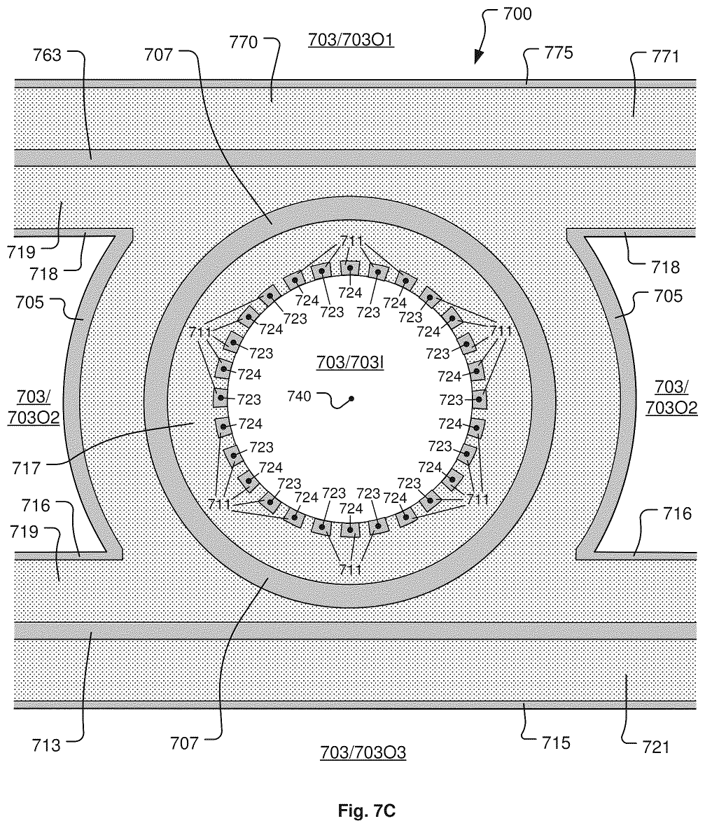

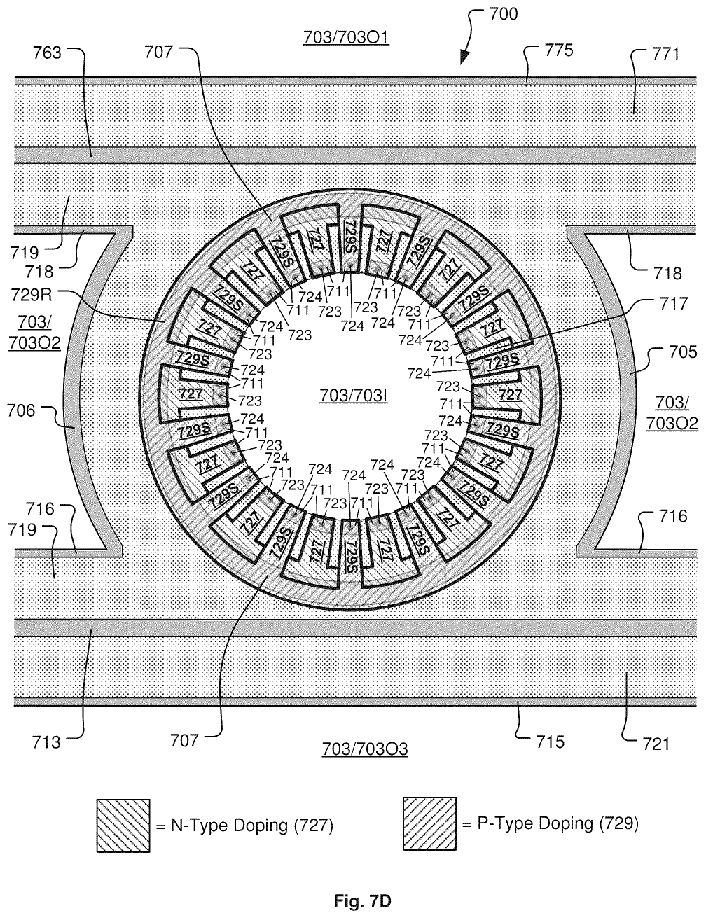

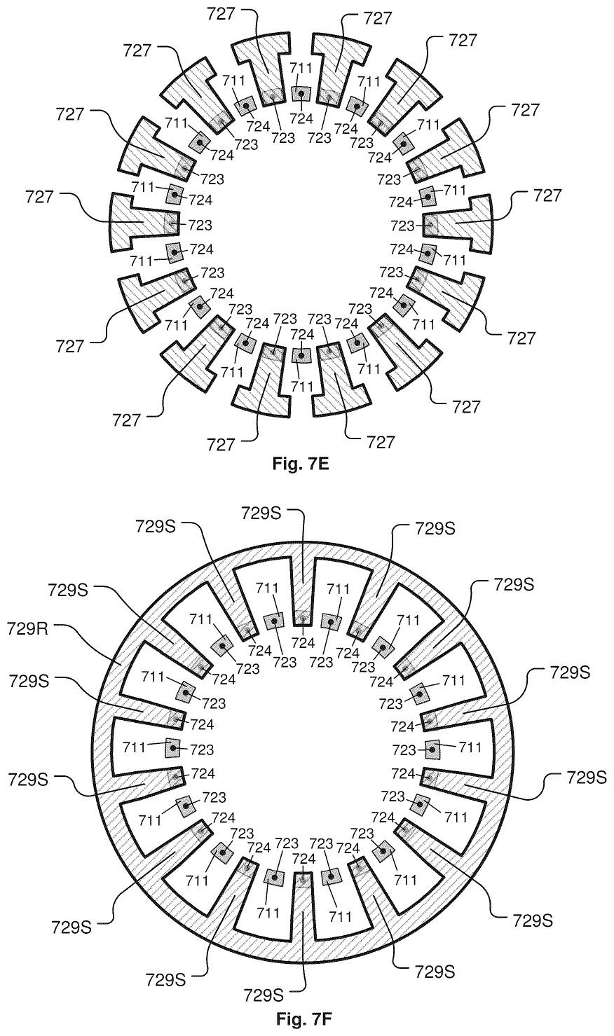

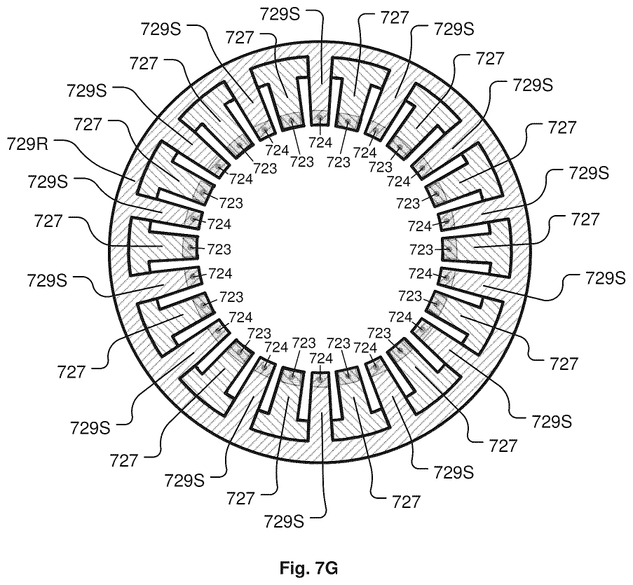

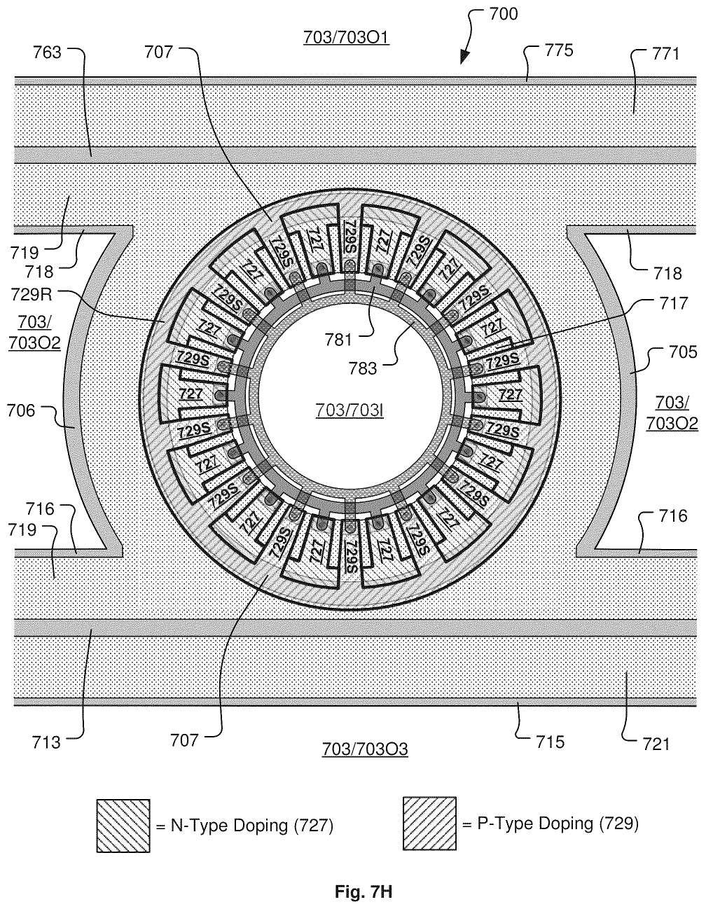

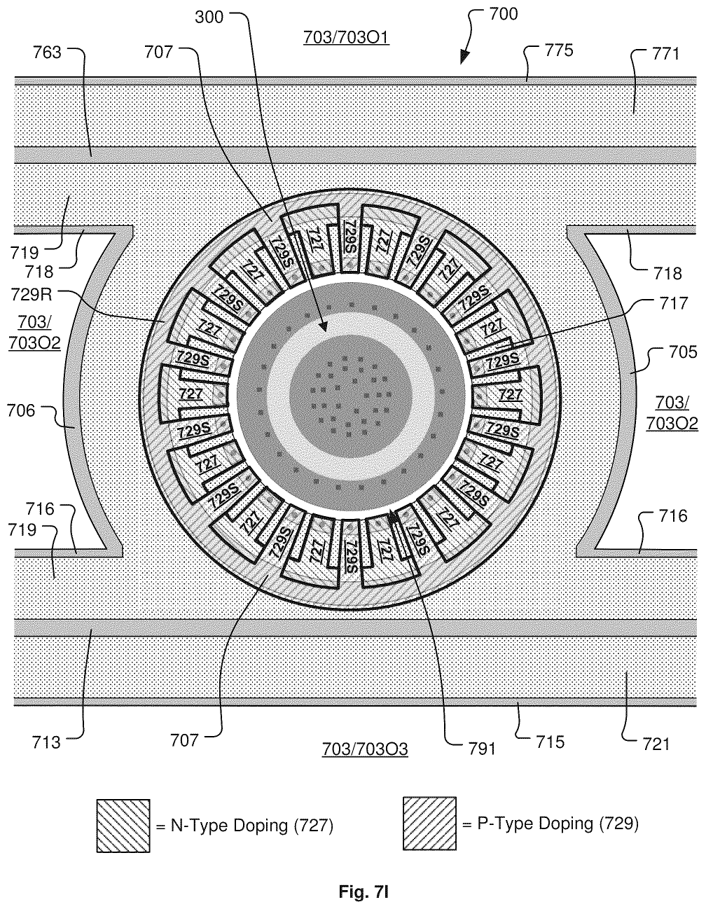

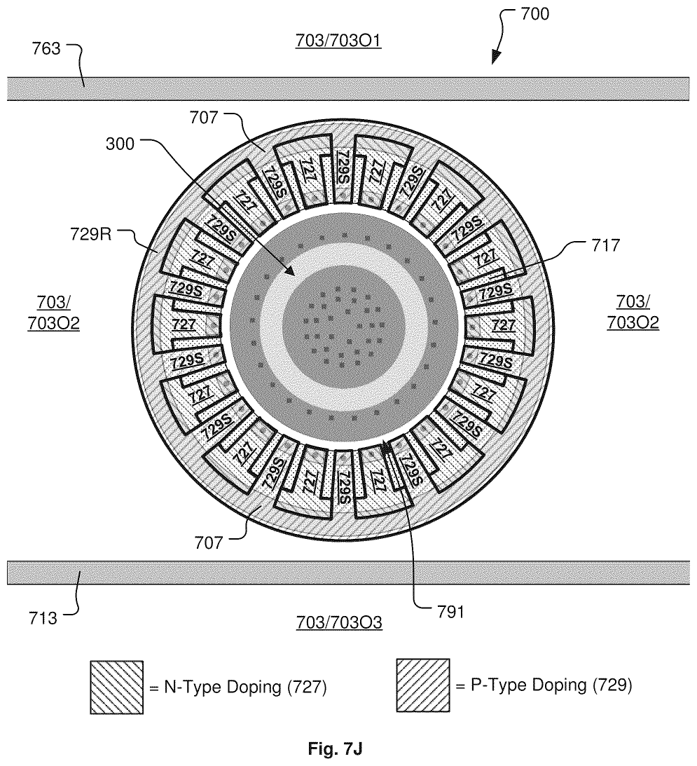

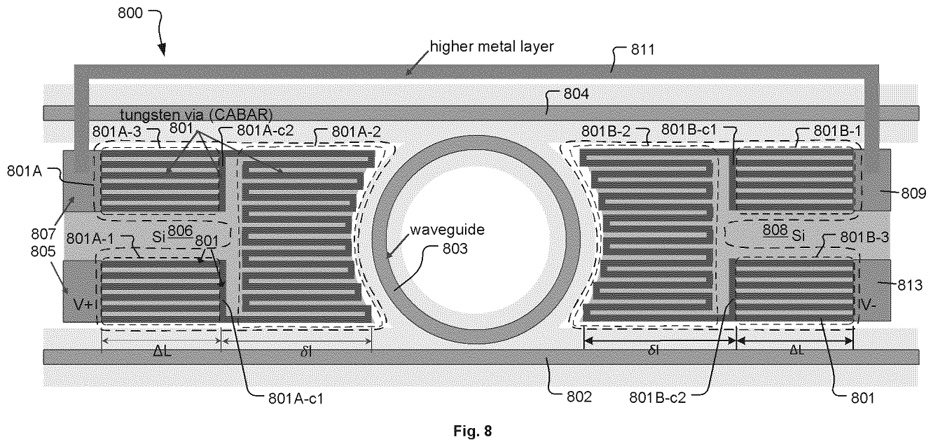

FIG. 7A shows a top view of a ring modulator 700 that implements a circuitous interdigitated diode configuration that extends through both a first optical coupling region 720 and a second optical coupling region 770, in accordance with some embodiments. The circuitous interdigitated diode configuration is formed in part by a P-type doped region 729 that includes a P-type doped outer rim region 729R and multiple P-type doped spoke regions 729S that extend inward from the P-type doped outer rim region 729R toward a center 740 of the ring modulator 700. Adjacently positioned ones of the multiple P-type doped spoke regions 729S are spaced apart from each other in an azimuthal direction about the center 740 of the ring modulator 700. The circuitous interdigitated diode configuration is also formed in part by multiple tab-shaped N-type doping regions 727, each of which is positioned within a space between two adjacently positioned ones of the multiple P-type doped spoke regions 729S. In this manner, the multiple P-type doped spoke regions 729S and the multiple tab-shaped N-type doping regions 727 are alternately positioned with respect to each other in the azimuthal direction about the center 740 of the ring modulator 700.

The first optical coupling region 720 is between a rib ring 707 of the ring modulator 700 and an optical waveguide 713. The second optical coupling region 770 is between the rib ring 707 of the ring modulator 700 and an optical waveguide 763. The rib ring 707 is formed as a rib optical waveguide that loops back into itself. A portion of the rib ring 707 extends through the optical coupling region 720. Another portion of the rib ring 707 extends through the optical coupling region 770. The ring modulator 700 is configured to optimize modulation efficiency while minimizing optical loss in each of the optical waveguide 713 and the optical waveguide 763. The ring modulator 700 is positioned so that the rib ring 707 is located within an evanescent optical coupling distance from the optical waveguide 713. The ring modulator 700 is also positioned so that the rib ring 707 is located within an evanescent optical coupling distance from the optical waveguide 763.

The rib ring 707 and each of the optical waveguide 713 and the optical waveguide 763 are formed as respective full-height (full-thickness) silicon regions. The rib ring 707 is surrounded by a partial-height (partial-thickness) silicon region 719. More specifically, the partial-height silicon region 719 extends around an outside wall of the rib ring 707. The rib ring 707 itself surrounds a partial-height (partial-thickness) silicon region 717. More specifically, the partial-height silicon region 717 extends around an inside wall of the rib ring 707. The optical waveguide 713 is bracketed by the partial-height (partial-thickness) silicon region 719 on a side of the optical waveguide 713 that faces toward the ring modulator 700, and is bracketed by a partial-height (partial-thickness) silicon region 721 on a side of the optical waveguide 713 that faces away from the ring modulator 700. The partial-height silicon region 719 also extends between the rib ring 707 and the optical waveguide 713. The optical waveguide 763 is bracketed by the partial-height (partial-thickness) silicon region 719 on a side of the optical waveguide 763 that faces toward the ring modulator 700, and is bracketed by a partial-height (partial-thickness) silicon region 771 on a side of the optical waveguide 763 that faces away from the ring modulator 700. The partial-height silicon region 719 also extends between the rib ring 707 and the optical waveguide 763.

A full-height (full-thickness) silicon region 705 extends along an outer radial periphery of a portion of the partial-height silicon region 719 that extends along an azimuthal angular span 728 about the center 740 of the ring modulator 700 radially outside of the rib ring 707. Also, a full-height (full-thickness) silicon region 706 extends along an outer radial periphery of a portion of the partial-height silicon region 719 that extends along an azimuthal angular span 730 about the center 740 of the ring modulator 700 radially outside of the rib ring 707. A full-height (full-thickness) silicon region 716 extends along the partial-height silicon region 719 on a side of the partial-height silicon region 719 that is located away from the optical waveguide 713. A full-height (full-thickness) silicon region 715 extends along the partial-height silicon region 721 on a side of the partial-height silicon region 721 that is located away from the optical waveguide 713. A full-height (full-thickness) silicon region 718 extends along the partial-height silicon region 719 on a side of the partial-height silicon region 719 that is located away from the optical waveguide 763. A full-height (full-thickness) silicon region 775 extends along the partial-height silicon region 771 on a side of the partial-height silicon region 771 that is located away from the optical waveguide 763. Full-height (full-thickness) silicon regions 711 are formed along an inner side of the partial-height silicon region 717 that is located away from the rib ring 707.

The ring modulator 700 is formed within an optical cladding material 703 that includes an inner optical cladding material 7031, a first outer optical cladding material 70301, a second outer optical cladding material 70302, and a third outer optical cladding material 70303. More specifically, in some embodiments, the inner optical cladding material 7031 is circumscribed by a combination of the full-height (full-thickness) silicon regions 711 and the partial-height silicon region 717. The first outer optical cladding material 70301 is present along a side of the full-height (full-thickness) silicon region 775 that is located away from the ring modulator 700. The second outer optical cladding material 70302 is present outside of the ring modulator 700 and between the full-height (full-thickness) silicon regions 716 and 718. The third outer optical cladding material 70303 is present along a side of the full-height (full-thickness) silicon region 715 that is located away from the ring modulator 700.

A number of inner electrical contacts 723 (shown as black dots) are formed in electrical connection with the full-height (full-thickness) silicon regions 711 over which the multiple tab-shaped N-type doping regions 727 are formed. A number of inner electrical contacts 724 (shown as black dots) are formed in electrical connection with the full-height (full-thickness) silicon regions 711 over which the multiple P-type doped spoke regions 729S are formed. The P-type doped outer rim region 729R includes a portion of the rib ring 707. Each of the multiple P-type doped spoke regions 729S includes a respective portion of the rib ring 707, a respective portion of the partial-height silicon region 717, and a respective one of the full-height (full-thickness) silicon regions 711. Each of the multiple tab-shaped N-type doping regions 727 includes a respective portion of the rib ring 707, a respective portion of the partial-height silicon region 717, and a respective one of the full-height (full-thickness) silicon regions 711. The tab-shaped N-type doping regions 727 and the P-type doped spoke regions 729S alternate in placement with respect to each other along the curvature of the rib ring 707 about the center 740 of the ring modulator 700. In this manner, the tab-shaped N-type doping regions 727, the P-type doped outer rim region 729R, and the multiple P-type doped spoke regions 729S collectively form the circuitous interdigitated diode configuration within the ring modulator 700 that extends through the optical coupling regions 720 and 770. In some embodiments, adjacently positioned ones of the tab-shaped N-type doping regions 727 and the P-type doped spoke regions 729S are separated from each other by a non-doped portion of the partial-height silicon region 717.

The N-type doping region 727 and the P-type doping region 729 interface with each other within the rib ring 707 to form a PN junction diode within the rib ring 707 that extends through both of the optical coupling regions 720 and 770. The tab-shaped N-type doping regions 727 provide respective electrically conductive pathways from the PN junction diode within the rib ring 707 to respective ones of the inner electrical contacts 723. The tab-shaped N-type doping regions 727 are collectively electrically connected through the inner electrical contacts 723 to a first node of an electrical circuit. The P-type doped spoke regions 729S provide respective electrically conductive pathways from the PN junction diode within the rib ring 707 to respective ones of the inner electrical contacts 724. The P-type doped outer rim region 729R and the P-type doped spoke regions 729S are collectively electrically connected through the inner electrical contacts 724 to a second node of an electrical circuit. In the ring modulator 700, the PN junction diode formed within the rib ring 707 extends through the optical coupling region 720 as indicated by arrow 722. Also, the PN junction diode formed within the rib ring 707 extends from the optical coupling region 720 to the optical coupling region 770 as indicated by arrow 728. Also, the PN junction diode formed within the rib ring 707 extends through the optical coupling region 770 as indicated by arrow 772. Also, the PN junction diode formed within the rib ring 707 extends from the optical coupling region 770 to the optical coupling region 720 as indicated by arrow 730.

FIGS. 7B through 7H show various states of fabrication to arrive at the example ring modulator 700 of FIG. 7A, in accordance with some embodiments. FIG. 7B shows a top view of a configuration of full-height (full-thickness) silicon 701 formed within the cladding material 703, in accordance with some embodiments. A portion of the configuration of full-height (full-thickness) silicon 701 is used to form the ring modulator 700. Another portion of the configuration of full-height (full-thickness) silicon 701 is used to form the optical waveguides 713 and 763 that extend past the ring modulator 700.

FIG. 7C shows a top view of the configuration of full-height (full-thickness) silicon 701 with portions of the full-height (full-thickness) silicon 701 etched away to form the partial-height (partial-thickness) silicon regions 717, 719, 721, and 771, in accordance with some embodiments. The thickness of the partial-height (partial-thickness) silicon regions 717, 719, 721, and 771 is less than the thickness of the full-height (full-thickness) silicon 701. The partial-height (partial-thickness) silicon regions 717, 719, 721, and 771 are configured and positioned such that a first remaining portion of the full-height (full-thickness) silicon 701 forms the rib ring 707, and such that a second remaining portion of the full-height (full-thickness) silicon 701 forms the outer silicon regions 705 and 706, and such that a third remaining portion of the full-height (full-thickness) silicon 701 forms the inner silicon regions 711, and such that a fourth remaining portion of the full-height (full-thickness) silicon 701 forms the optical waveguide 713, and such that a fifth remaining portion of the full-height (full-thickness) silicon 701 forms the full-height (full-thickness) silicon region 716, and such that a sixth remaining portion of the full-height (full-thickness) silicon 701 forms the full-height (full-thickness) silicon region 715, and such that a seventh remaining portion of the full-height (full-thickness) silicon 701 forms the optical waveguide 763, and such that a eighth remaining portion of the full-height (full-thickness) silicon 701 forms the full-height (full-thickness) silicon region 718, and such that a ninth remaining portion of the full-height (full-thickness) silicon 701 forms the full-height (full-thickness) silicon region 775. FIG. 7C also shows formation of the inner electrical contacts 723 and 724 in electrical connection with the full-height (full-thickness) silicon regions 711 positioned along the inner radius of the ring modulator 700. In some embodiments, the inner electrical contacts 723 and 724 are substantially uniformly azimuthally spaced about the center 740 of the ring modulator 700.

FIG. 7D shows a top view of the partially formed ring modulator 700 of FIG. 7C having the N-type doping region 727 and the P-type doping region 729 formed thereon, in accordance with some embodiments. The N-type doping regions 727 are electrically connected to respective ones of the inner electrical contacts 723 by way of respective ones of the inner full-height (full-thickness) silicon regions 711. The P-type doped spoke regions 729S are electrically connected to respective ones of the inner electrical contacts 724 by way of respective ones of the inner full-height (full-thickness) silicon regions 711.

FIG. 7E shows an isolated top view of the N-type doping regions 727, in accordance with some embodiments. FIG. 7F shows an isolated top view of the P-type doping region 729, including the P-type doped outer rim region 729R and multiple P-type doped spoke regions 729S, in accordance with some embodiments. The P-type doped outer rim region 729R and the multiple P-type doped spoke regions 729S are integrally formed with each other, so as to be electrically connected to each other. FIG. 7G shows an isolated view of the N-type doping regions 727 and the P-type doping region 729 positioned relative to each other as in the ring modulator 700, in accordance with some embodiments.

FIG. 7H shows the top view of the ring modulator 700 of FIG. 7D with the N-type doping regions 727 electrically connected to a first electrical node by way of an electrical conductor 781, in accordance with some embodiments. The electrical conductor 781 is electrically connected to the inner electrical contacts 723 that are electrically connected to one of N-type doping regions 727. FIG. 7H also shows the P-type doping region 729 electrically connected to a second electrical node by way of an electrical conductor 783 by way of the P-type doped spoke regions 729S and corresponding inner electrical contacts 724.

Each of the P-type doping region 729 and the N-type doping regions 727 is doped with impurity ions to form the lateral PN junction diode within the rib ring 707. In some embodiments, the P-type doping region 729 is doped with acceptor impurity atoms, and the N-type doping regions 727 are doped with donor impurity atoms. In this manner, the N-type doping regions 727 and the P-type doping region 729 are doped with opposite polarity. The interface between the N-type doping regions 727 and the P-type doping region 729 within the rib ring 707 is the PN junction of the lateral PN junction diode. At the PN junction within the rib ring 707, the free electrons diffuse into the P-type doping region 729, and the holes (electron vacancies) diffuse into the N-type doping regions 727, which causes a depletion region to form along the PN junction within the rib ring 707. It should be appreciated that in the ring modulator 700, the PN junction diode formed by the P-type doping region 729 and the N-type doping regions 727 extends through both the optical coupling region 720 and the optical coupling region 770. Within each of the optical coupling regions 720 and 770, the N-type doping regions 727 formed within the partial-height (partial-thickness) silicon region 717 provide respective electrically conductive paths between the inner electrical contacts 723 and the depletion region formed along the PN junction within the rib ring 707. Also, within each of the optical coupling regions 720 and 770, the P-type doped spoke regions 729S formed within the partial-height (partial-thickness) silicon region 717 provide respective electrically conductive paths between the inner electrical contacts 724 and the depletion region formed along the PN junction within the rib ring 707. Also, along the rib ring 707 between the optical coupling regions 720 and 770, the N-type doping regions 727 formed within the partial-height (partial-thickness) silicon region 717 provide electrically conductive paths between the inner electrical contacts 723 and the depletion region formed along the PN junction within the rib ring 707. Also, along the rib ring 707 between of the optical coupling regions 720 and 770, the P-type doped spoke regions 729S formed within the partial-height (partial-thickness) silicon region 717 provide electrically conductive paths between the inner electrical contacts 724 and the depletion region formed along the PN junction within the rib ring 707.

In some embodiments, with the lateral PN junction diode within the rib ring 707 electrically connected in a reverse-biased manner to an electrical voltage source, the inner electrical contacts 723 of the N-type doping regions 727 are electrically connected to the anode of the electrical voltage source by way of the electrical conductor 781. Also, in some embodiments, with the lateral PN junction diode within the rib ring 707 electrically connected in a reverse-biased manner to the electrical voltage source, the inner electrical contacts 724 of the P-type doping region 729 are electrically connected to the cathode of the electrical voltage source. The inner electrical contacts 723 and 724 are positioned far enough from the rib ring 707 to reduce optical absorption of the light traveling through the rib ring 707 by metal and silicided regions that form the inner electrical contacts 723 and 724.

In the ring modulator 700, the lateral PN junction diode extends into the optical coupling region 720 of the ring modulator 700 without adversely affecting optical absorption loss in the optical waveguide 713 to which the ring modulator 700 is optically coupled. Also, positioning of the N-type doping regions 727 and the P-type doped spoke regions 729S on the inside of the rib ring 707 so as to extend toward the center 740 of ring modulator 700 enables the lateral PN junction diode to extend through the optical coupling region 720 of the ring modulator 700 without adversely affecting optical absorption loss in the optical waveguide 713 to which the ring modulator 700 is optically coupled. Additionally, by having the N-type doping regions 727 and the P-type doped spoke regions 729S alternatively positioned along the arc of the rib ring 707 within the optical coupling region 720, the electrical series resistance in the lateral PN junction diode of the ring modulator 700 is not adversely increased by having the lateral PN junction diode extend through the optical coupling region 720.

In the ring modulator 700, the lateral PN junction diode extends into the optical coupling region 770 of the ring modulator 700 without adversely affecting optical absorption loss in the optical waveguide 763 to which the ring modulator 700 is optically coupled. Also, positioning of the N-type doping regions 727 and the P-type doped spoke regions 729S on the inside of the rib ring 707 so as to extend toward the center 740 of ring modulator 700 enables the lateral PN junction diode to extend through the optical coupling region 770 of the ring modulator 700 without adversely affecting optical absorption loss in the optical waveguide 763 to which the ring modulator 700 is optically coupled. Additionally, by having the N-type doping regions 727 and P-type doped spoke regions 729S alternatively positioned along the arc of the rib ring 707 within the optical coupling region 770, the electrical series resistance in the lateral PN junction diode of the ring modulator 700 is not adversely increased by having the lateral PN junction diode extend through the optical coupling region 770.

The ring modulator 700 uses the circuitous interdigitated PN junction diode design (interdigitation of the N-type doping regions 727 and P-type doped spoke regions 729S) around the entirety of the rib ring 707, including through portions of the rib ring 707 that pass through each of the optical coupling regions 720 and 770. Within the optical coupling region 720, the inner electrical contacts 723 and 724 are positioned along the inner region of the ring modulator 700, far from the rib ring 707 and even farther from the optical waveguide 713, so as to avoid optical absorption loss in the coupling optical waveguides 707 and 713. Similarly, within the optical coupling region 770, the inner electrical contacts 723 and 724 are positioned along the inner region of the ring modulator 700, far from the rib ring 707 and even farther from the optical waveguide 763, so as to avoid optical absorption loss in the coupling optical waveguides 707 and 763. The circuitous interdigitated N-type doping regions 727 and the P-type doped spoke regions 729S alternate polarity (alternate cathode and anode) around the rib ring 707, including through each of the optical coupling regions 720 and 770.

In various embodiments, electrically conductive structures, e.g., metal traces/wires, and electrically conductive via structures are formed in and/or through different levels of the semiconductor device in which the ring modulator 700 is formed in order to electrically connect all of the inner electrical contacts 723 that are electrically connected to the N-type doping regions 727 to the same first electrical node, such as exemplified by the electrical conductor 781. In various embodiments, electrically conductive structures, e.g., metal traces/wires, and electrically conductive via structures are formed in and/or through different levels of the semiconductor device in which the ring modulator 700 is formed in order to electrically connect all of the inner electrical contacts 724 that are electrically connected to the P-type doping region 729 to the same second electrical node, such as exemplified by the electrical conductor 783.

In accordance with the foregoing, the ring resonator 700 includes a built-in diode for modulating an optical signal propagating through the optical waveguide 713 and/or the optical waveguide 763. The optical mode supported by the ring resonator 700 has significant power density that overlaps the depletion region of the PN junction diode within the rib ring 707. By changing the voltage differential between the anode and cathode of the PN junction diode within the rib ring 707, charge carriers can be added to or removed from the depletion region of the PN junction within the rib ring 707 in a controlled manner, which provides for changing of the refractive index and optical absorption coefficient of the rib ring 707 in a controlled manner by way of the plasma effect, which in turn provides for changing of the amplitude and phase of the light that is transmitted on through the optical waveguide 713 and/or the optical waveguide 763 past the ring modulator 700 in a controlled manner. In some embodiments, the PN junction diode within the rib ring 707 of the ring modulator 700 is operated in a reversed bias manner to enable fast charge transport and correspondingly high optical modulation data rates.

In some embodiments, the optical waveguide 713 and/or the optical waveguide 763 carries multiple wavelength channels of light, where only one of the multiple wavelength channels of light is coupled into and modulated by the ring resonator 700 in a controlled and selectable manner. In some embodiments, such as in WDM systems, multiple instances of the ring resonator 700 are optically coupled to the same optical waveguide 713 and/or the optical waveguide 763, with each of the ring resonators 700 tuned to modulate a different one of the multiple wavelength channels of light propagating through the optical waveguide 713 and/or the optical waveguide 763. The metal of the inner electrical contacts 723 and 724 absorbs light across all wavelengths. Therefore, by having the inner electrical contacts 723 and 724 positioned away from the optical waveguides 713 and 763, e.g., by a distance greater than or equal to about one micrometer, within each instance of the ring modulator 700, it is possible to avoid introduction and accumulation of excess absorption loss of the light propagating through the optical waveguides 713 and 763, across every wavelength channel of light. Also, by having the contacts 723 and 724 positioned on the inner radius of the ring modulator 700, the area along the outer radius of the ring modulator 700 is available for positioning of one or more heating device(s), e.g., resistive heating device(s), to provide for thermal resonance wavelength tuning of the ring resonator 700. In some embodiments, doped or silicided silicon is used to form one or more resistive heating device(s) along the outer radius of the ring modulator 700, such as along the full-height (full-thickness) silicon regions 705 and 706.

FIG. 7I shows a top view of the ring modulator 700 of FIG. 7A with the doped-silicon non-silicided resistive radial-current heater 300 of FIG. 3 disposed inside of the ring modulator 700, in accordance with some embodiments. More specifically, the doped-silicon non-silicided resistive radial-current heater 300 is disposed within the region circumscribed by the collection of the full-height (full-thickness) silicon regions 711 and the partial-height silicon region 717 of the ring modulator 400. The silicon of the doped-silicon non-silicided resistive radial-current heater 300 displaces the inner optical cladding material 7031. In some embodiments, an oxide region 791 radially separates the silicon of the doped-silicon non-silicided resistive radial-current heater 300 from the silicon of the ring modulator 400.

FIG. 7J shows a top view of the ring modulator 700 of FIG. 7H with the doped-silicon non-silicided resistive radial-current heater 300 of FIG. 3 disposed inside of the ring modulator 700, and with the rib ring 707 of the ring modulator 700 surrounded by the outer optical cladding material 70302, in accordance with some embodiments. In some embodiments, the outer optical cladding material 70302 is formed of an oxide material disposed within a region in which the silicon is fully etched. Also, in the embodiment of FIG. 7J, the optical waveguide 713 is bounded on its outer side by the outer optical cladding material 70302. In some embodiments, the outer optical cladding material 70303 is formed as an oxide material disposed within a region in which the silicon is fully etched. Also, in the embodiment of FIG. 7J, the optical waveguide 763 is bounded on its outer side by the outer optical cladding material 70301. In some embodiments, the outer optical cladding material 70301 is formed as an oxide material disposed within a region in which the silicon is fully etched.

In an example embodiment, an electro-optical semiconductor chip includes a ring-shaped optical waveguide circumscribing an interior region of a microring resonator device. The electro-optical semiconductor chip also includes a bus optical waveguide extending past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a doped ring of silicon disposed within the interior region of the microring resonator device concentric with the ring-shaped optical waveguide. The electro-optical semiconductor chip also includes an inner region of silicided silicon formed along an inner edge of the doped ring of silicon. The electro-optical semiconductor chip also includes an outer region of silicided silicon formed along an outer edge of the doped ring of silicon. The electro-optical semiconductor chip also includes a first plurality of electrical contacts disposed to electrically contact the outer region of silicided silicon. The electro-optical semiconductor chip also includes a second plurality of electrical contacts disposed to electrically contact the inner region of silicided silicon. A voltage differential between the first plurality of electrical contacts and the second plurality of electrical contacts is used to control an electrical current flow through the doped ring of silicon to control a temperature of the ring-shaped optical waveguide.

In some example embodiments, the doped ring of silicon, the inner region of silicided silicon, and the outer region of silicided silicon are formed as respective portions of a same monolithic silicon structure. In some example embodiments, the inner region of silicided silicon is ring-shaped, and the outer region of silicided silicon is ring-shaped. In some example embodiments, the inner region of silicided silicon is disc-shaped, and the outer region of silicided silicon is ring-shaped.

In some example embodiments, the first plurality of electrical contacts are arranged in a substantially uniform distribution around the ring-shaped optical waveguide within the outer region of silicided silicon. In some example embodiments, the second plurality of electrical contacts are arranged in a substantially uniform distribution within the inner region of silicided silicon. In some example embodiments, the outer region of silicided silicon is spaced apart from the ring-shaped optical waveguide around an entire inner circumference of the ring-shaped optical waveguide. In some example embodiments, an oxide region is disposed between the outer region of silicided silicon and the ring-shaped optical waveguide around an entire inner circumference of the ring-shaped optical waveguide. In some example embodiments, the first plurality of electrical contacts is formed as a first dense collection of via structures configured to pull excess heat out of the outer region of silicided silicon, and the second plurality of electrical contacts is formed as a second dense collection of via structures configured to pull excess heat out of the inner region of silicided silicon.

In some example embodiments, the ring-shaped optical waveguide is a rib ring-shaped optical waveguide that includes a rib ring that has a full height, an outer silicon region that has a partial-height and surrounds the rib ring, and an inner silicon region that has a partial-height and is surrounded by the rib ring. In these embodiments, the rib ring, the outer silicon region, and the inner silicon region are integrally formed as respective portions of a same silicon structure. In these embodiments, the outer silicon region extends between the rib ring and the bus optical waveguide. In these embodiments, the outer region of silicided silicon is spaced apart from the inner silicon region of the rib ring-shaped optical waveguide. In some example embodiments, an oxide region is disposed between the outer region of silicided silicon and the inner silicon region of the rib ring-shaped optical waveguide. In some example embodiments, the oxide region has a non-zero radial thickness within a range extending up to about 200 nanometers.

In some example embodiments, the above-mentioned bus optical waveguide is a first bus optical waveguide, and the above-mentioned optical coupling region is a first optical coupling region. In these embodiments, the electro-optical semiconductor chip further includes a second bus optical waveguide extending past the ring-shaped optical waveguide and within an evanescent optical coupling distance of the ring-shaped optical waveguide, such that a second optical coupling region exists between the second bus optical waveguide and the ring-shaped optical waveguide. In these embodiments, the first optical coupling region and the second optical coupling region are diametrically opposed to each other relative to the ring-shaped optical waveguide.

In an example embodiment, an electro-optical semiconductor chip includes a ring-shaped optical waveguide and a bus optical waveguide that extends past the ring-shaped optical waveguide and within an evanescent optical coupling distance of the ring-shaped optical waveguide, such that an optical coupling region exists between the bus optical waveguide and the ring-shaped optical waveguide. The electro-optical semiconductor chip also includes a doped-silicon non-silicided region disposed outside of the ring-shaped optical waveguide and within thermal communication with the ring-shaped optical waveguide. The electro-optical semiconductor chip also includes an inner contact region formed of silicided silicon along an inner side of the doped-silicon non-silicided region. The electro-optical semiconductor chip also includes an outer contact region formed of silicided silicon along an outer side of the doped-silicon non-silicided region. The electro-optical semiconductor chip also includes a first plurality of electrical contacts disposed to electrically contact the inner contact region. The electro-optical semiconductor chip also includes a second plurality of electrical contacts disposed to electrically contact the outer contact region. A voltage differential between the first plurality of electrical contacts and the second plurality of electrical contacts is used to control an electrical current flow through the doped-silicon non-silicided region to control a temperature of at least a portion of the ring-shaped optical waveguide.

In some example embodiments, the doped-silicon non-silicided region, the inner contact region, and the outer contact region are formed as respective portions of a same monolithic silicon structure. In some example embodiments, the same monolithic silicon structure has a curvature that follows a curvature of the ring-shaped optical waveguide. In some example embodiments, an oxide region is disposed between the inner contact region and the ring-shaped optical waveguide.

In some example embodiments, the above-mentioned doped-silicon non-silicided region is a first doped-silicon non-silicided region, and the above-mentioned inner contact region is a first inner contact region, and the above-mentioned outer contact region is a first outer contact region. In these embodiments, the electro-optical semiconductor chip further includes a second doped-silicon non-silicided region disposed outside of the ring-shaped optical waveguide and within thermal communication with the ring-shaped optical waveguide. In these embodiments, the electro-optical semiconductor chip further includes a second inner contact region formed of silicided silicon along an inner side of the second doped-silicon non-silicided region. In these embodiments, the electro-optical semiconductor chip further includes a second outer contact region formed of silicided silicon along an outer side of the second doped-silicon non-silicided region. In these embodiments, the electro-optical semiconductor chip further includes a third plurality of electrical contacts disposed to electrically contact the second inner contact region. In these embodiments, the electro-optical semiconductor chip further includes a fourth plurality of electrical contacts disposed to electrically contact the second outer contact region. A voltage differential between the third plurality of electrical contacts and the fourth plurality of electrical contacts is used to control an electrical current flow through the second doped-silicon non-silicided region to control a temperature of at least a portion of the ring-shaped optical waveguide.

In some example embodiments, the first doped-silicon non-silicided region, the first inner contact region, and the first outer contact region are formed as respective portions of a first monolithic silicon structure. Also, the second doped-silicon non-silicided region, the second inner contact region, and the second outer contact region are formed as respective portions of a second monolithic silicon structure that is physically separated from the first monolithic silicon structure. In some example embodiments, the first monolithic silicon structure has a curvature that follows a curvature of the ring-shaped optical waveguide, and the second monolithic silicon structure has a curvature that follows the curvature of the ring-shaped optical waveguide. In some example embodiments, a first oxide region is disposed between the first monolithic silicon structure and the ring-shaped optical waveguide, and a second oxide region is disposed between the second monolithic silicon structure and the ring-shaped optical waveguide.

In some example embodiments, the above-mentioned bus optical waveguide is a first bus optical waveguide, and the above-mentioned optical coupling region is a first optical coupling region. In these embodiments, the electro-optical semiconductor chip further includes a second bus optical waveguide extending past the ring-shaped optical waveguide and within an evanescent optical coupling distance of the ring-shaped optical waveguide, such that a second optical coupling region exists between the second bus optical waveguide and the ring-shaped optical waveguide. In these embodiments, the first optical coupling region and the second optical coupling region are diametrically opposed to each other relative to the ring-shaped optical waveguide. In these embodiments, the first monolithic silicon structure is disposed within a first region extending between the first bus optical waveguide and the second bus optical waveguide on a first side of the ring-shaped optical waveguide. In these embodiments, the second monolithic silicon structure is disposed within a second region extending between the first bus optical waveguide and the second bus optical waveguide on a second side of the ring-shaped optical waveguide. In some of these embodiments, the first monolithic silicon structure and the second monolithic silicon structure are positioned at diametrically opposed locations outside of the ring-shaped optical waveguide. In some of these embodiments, the first monolithic silicon structure has a curvature that follows a curvature of the ring-shaped optical waveguide, and the second monolithic silicon structure has a curvature that follows the curvature of the ring-shaped optical waveguide. In some of these embodiments, a first oxide region is disposed between the first monolithic silicon structure and the ring-shaped optical waveguide, and a second oxide region is disposed between the second monolithic silicon structure and the ring-shaped optical waveguide.

In some example embodiments, the ring-shaped optical waveguide is a rib ring-shaped optical waveguide that includes a rib ring that has a full height, an outer silicon region that has a partial-height and surrounds the rib ring, and an inner silicon region that has a partial-height and is surrounded by the rib ring. In these embodiments, the rib ring, the outer silicon region, and the inner silicon region are integrally formed as respective portions of a same silicon structure. In these embodiments, the outer silicon region extends between the rib ring and each of the first bus optical waveguide and the second bus optical waveguide. In these embodiments, each of the first monolithic silicon structure and the second monolithic silicon structure is spaced apart from the outer silicon region of the rib ring-shaped optical waveguide. In some of these embodiments, a first oxide region is disposed between the first monolithic silicon structure and the outer silicon region of the rib ring-shaped optical waveguide, and a second oxide region is disposed between the second monolithic silicon structure and the outer silicon region of the rib ring-shaped optical waveguide.

In some example embodiments, a doped-silicon non-silicided resistive radial-current heater is formed within an interior region that is circumscribed by the ring-shaped optical waveguide. In these embodiments, the doped-silicon non-silicided resistive radial-current heater includes a doped ring of silicon, an inner region of silicided silicon formed along an inner edge of the doped ring of silicon, and an outer region of silicided silicon formed along an outer edge of the doped ring of silicon. In these embodiments, the doped-silicon non-silicided resistive radial-current heater also includes a fifth plurality of electrical contacts disposed to electrically contact the outer region of silicided silicon. In these embodiments, the doped-silicon non-silicided resistive radial-current heater also includes a sixth plurality of electrical contacts disposed to electrically contact the inner region of silicided silicon. A voltage differential between the fifth plurality of electrical contacts and the sixth plurality of electrical contacts is used to control an electrical current flow through the doped ring of silicon to control a temperature of at least a portion of the ring-shaped optical waveguide.

FIG. 8 shows a top view of a microring resonator device 800 that implements a tungsten-via-based resistive heater 801 outside of a ring-shaped optical waveguide 803, in accordance with some embodiments. In some embodiments, the ring-shaped optical waveguide 803 is positioned within an evanescent optical coupling distance of an optical waveguide 802. In some embodiments, the ring-shaped optical waveguide 803 is also positioned within an evanescent optical coupling distance of an optical waveguide 804. Tungsten (W) interconnects are known to be less susceptible to failures caused by electromigration compared to copper (Cu) interconnects and aluminum (Al) interconnects. In some embodiments, a silicon photonics fabrication process forms one or more tungsten metallization structures as part of forming one or more electrical resistance heater(s) for a photonic device, such as for a thermo-optic phase shifter or for a ring modulator or for a microring resonator, among other devices. The tungsten-via-based resistive heater 801 is formed using rectangular-shaped bar vias made of tungsten. The tungsten-via-based resistive heater 801 includes a first contiguous tungsten bar via structure 801A on a first side of the ring-shaped optical waveguide 803, and a second contiguous tungsten bar via structure 801B on a second side of the ring-shaped optical waveguide 803. In some embodiments, the first contiguous tungsten bar via structure 801A is formed over a silicon structure 806. In some embodiments, the second contiguous tungsten bar via structure 801B is formed over a silicon structure 808.

The first contiguous tungsten bar via structure 801A includes a first group of bar via structures 801A-1 physically and electrically connected to a first contact structure 805. In some embodiments, the first contact structure 805 is formed of copper. However, in other embodiments, the first contact structure 805 is formed of an electrically conductive material other than copper. The first contiguous tungsten bar via structure 801A also includes a second group of bar via structures 801A-2 physically and electrically connected to the first group of bar via structures 801A-1 by way of a bar via structure 801A-c1. The second group of bar via structures 801A-2 is configured to have a serpentine shape. A side of the second group of bar via structures 801A-2 closest to the ring-shaped optical waveguide 803 is configured to have a shape that is substantially conformal with a curvature of the ring-shaped optical waveguide 803. In some embodiments, a substantially uniform separation distance is established between the ring-shaped optical waveguide 803 and the side of the second group of bar via structures 801A-2 closest to the ring-shaped optical waveguide 803 along the curvature of the ring-shaped optical waveguide 803. The first contiguous tungsten bar via structure 801A also includes a third group of bar via structures 801A-3 physically and electrically connected to the second group of bar via structures 801A-2 by way of a bar via structure 801A-c2. The third group of bar via structures 801A-3 are physically and electrically connected to a second contact structure 807. In some embodiments, the second contact structure 807 is formed of copper. However, in other embodiments, the second contact structure 807 is formed of an electrically conductive material other than copper. The second contact structure 807 is electrically connected to a third contact structure 809 through a combination of via structures and metal interconnect structures within one or more higher levels of the photonic chip in which the microring resonator device 800 is formed, as indicated by a structure 811. In some embodiments, the third contact structure 809 is formed of copper. However, in other embodiments, the third contact structure 809 is formed of an electrically conductive material other than copper.

The second contiguous tungsten bar via structure 801B includes a first group of bar via structures 801B-1 physically and electrically connected to the third contact structure 809. The second contiguous tungsten bar via structure 801B also includes a second group of bar via structures 801B-2 physically and electrically connected to the first group of bar via structures 801B-1 by way of a bar via structure 801B-c1. The second group of bar via structures 801B-2 is configured to have a serpentine shape. A side of the second group of bar via structures 801B-2 closest to the ring-shaped optical waveguide 803 is configured to have a shape that is substantially conformal with a curvature of the ring-shaped optical waveguide 803. In some embodiments, a substantially uniform separation distance is established between the ring-shaped optical waveguide 803 and the side of the second group of bar via structures 801B-2 closest to the ring-shaped optical waveguide 803 along the curvature of the ring-shaped optical waveguide 803. The second contiguous tungsten bar via structure 801B also includes a third group of bar via structures 801B-3 physically and electrically connected to the second group of bar via structures 801B-2 by way of a bar via structure 801B-c2. The third group of bar via structures 801B-3 are physically and electrically connected to a fourth contact structure 813. In some embodiments, the fourth contact structure 813 is formed of copper. However, in other embodiments, the fourth contact structure 813 is formed of an electrically conductive material other than copper.

Via structures in CMOS fabrication typically electrically connect the silicon device layer of the chip to the first metal interconnect layer (M1), such that electrical current flows vertically between the silicon device layer and the first metal interconnect layer (M1). In contrast to this typical function of via structures, the tungsten-via-based resistive heater 801 is configured to direct a flow of electrical current horizontally through each of the first contiguous tungsten bar via structure 801A and the second contiguous tungsten bar via structure 801B. More specifically, the tungsten-via-based resistive heater 801 is configured so that electrical continuity is established from the first contact structure 805 through the first contiguous tungsten bar via structure 801A, through the second contact structure 807, through the upper level electrically conductive structure 811, through the third contact structure 809, through the second contiguous tungsten bar via structure 801B, to the fourth contact structure 813. A first voltage is applied to the first contact structure 805 and a second voltage is applied to the fourth contact structure 813. A voltage difference between the first voltage and the second voltage is controlled to cause a controlled flow of electrical current through the tungsten-via-based resistive heater 801 between the first contact structure 805 and the fourth contact structure 813, which causes a controlled amount of heat generation within each of the first contiguous tungsten bar via structure 801A and the second contiguous tungsten bar via structure 801B, which heats the silicon structure 806 and the silicon structure 808, respectively.

Due to difference in diffusion coefficients, connection points between different metals are often weak spots for electromigration, especially at higher temperatures. In the tungsten-via-based resistive heater 801, connection points between the tungsten of the first contiguous tungsten bar via structure 801A and each of the first contact structure 805 and the second contact structure 807 can be positioned away from the region where most of the heat is generated within second group of bar via structures 801A-2, as indicated by a length ΔL of each of the first group of bar via structures 801A-1 and the third group of bar via structures 801A-3 being greater than a length 81 of the second group of bar via structures 801A-2 (ΔL>>δ1). Similarly, in the tungsten-via-based resistive heater 801, connection points between the tungsten of the second contiguous tungsten bar via structure 801B and each of the third contact structure 809 and the fourth contact structure 813 can be positioned away from the region where most of the heat is generated within second group of bar via structures 801B-2, as indicated by a length ΔL of each of the first group of bar via structures 801B-1 and the third group of bar via structures 801B-3 being greater than a length 81 of the second group of bar via structures 801B-2 (ΔL>>δ1). It should also be appreciated that the tungsten-via-based resistive heater 801 is implementable in a CMOS chip design that does not have a dedicated tungsten layer available.

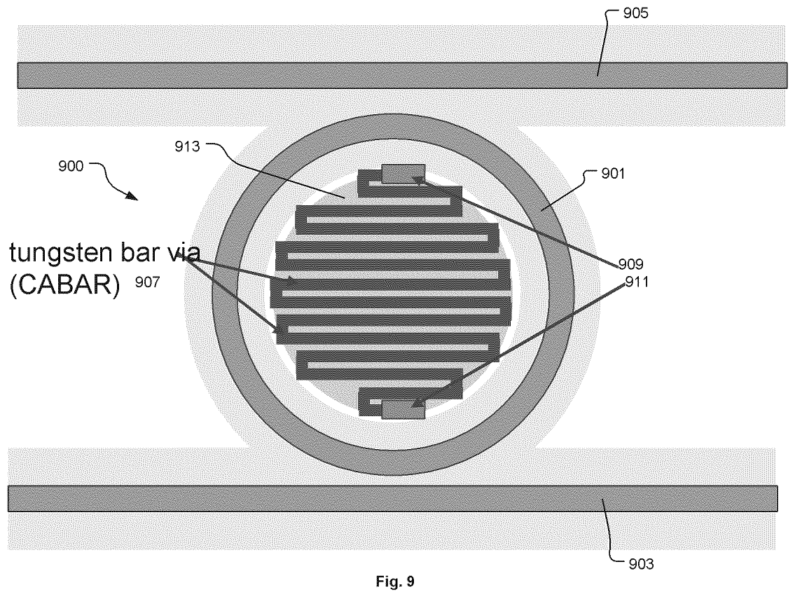

FIG. 9 shows a top view of a microring resonator device 900 that implements a tungsten-via-based resistive heater 907 inside of a ring-shaped optical waveguide 901, in accordance with some embodiments. In some embodiments, the ring-shaped optical waveguide 901 is positioned within an evanescent optical coupling distance of an optical waveguide 903. In some embodiments, the ring-shaped optical waveguide 901 is also positioned within an evanescent optical coupling distance of an optical waveguide 905. The tungsten-via-based resistive heater 907 is formed using contiguously formed rectangular-shaped bar vias made of tungsten. The tungsten-via-based resistive heater 907 is formed over a silicon structure 913 within the region inside of the ring-shaped optical waveguide 901. The tungsten-via-based resistive heater 907 is configured to have a substantially serpentine shape extending from a first contact structure 909 to a second contact structure 911. It should be appreciated that positioning of the tungsten-via-based resistive heater 907 within the region inside of the ring-shaped optical waveguide 901 provides for improved power efficiency, e.g., higher nanometer per milliwatt (nm/mW), and/or higher gigahertz per microwatt (GHz/μW).

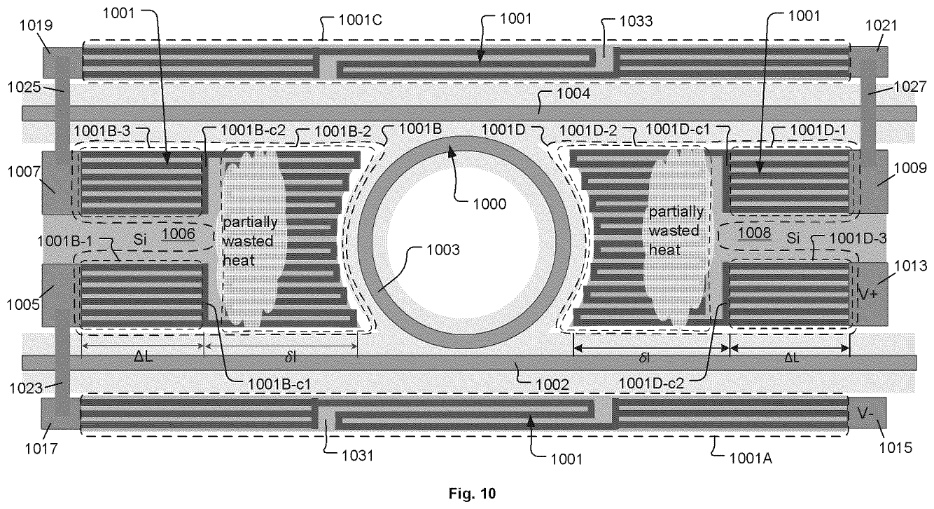

FIG. 10 shows a top view of a microring resonator device 1000 that implements a tungsten-via-based resistive heater 1001 outside of a ring-shaped optical waveguide 1003, along an optical waveguide 1002, and along an optical waveguide 1004, in accordance with some embodiments. In some embodiments, the ring-shaped optical waveguide 1003 is positioned within an evanescent optical coupling distance of each of the optical waveguide 1002 and the optical waveguide 1004. The tungsten-via-based resistive heater 1001 is formed using rectangular-shaped bar vias made of tungsten. The tungsten-via-based resistive heater 1001 includes a first contiguous tungsten bar via structure 1001A along the optical waveguide 1002, a second contiguous tungsten bar via structure 1001B on a first side of the ring-shaped optical waveguide 1003, a third contiguous tungsten bar via structure 1001C along the optical waveguide 1004, and a fourth contiguous tungsten bar via structure 1001D on a second side of the ring-shaped optical waveguide 1003. In some embodiments, the first contiguous tungsten bar via structure 1001A is formed over a silicon structure 1031. In some embodiments, the second contiguous tungsten bar via structure 1001B is formed over a silicon structure 1006. In some embodiments, the third contiguous tungsten bar via structure 1001C is formed over a silicon structure 1033. In some embodiments, the fourth contiguous tungsten bar via structure 1001D is formed over a silicon structure 1008.

The first contiguous tungsten bar via structure 1001A includes a contiguous collection of bar via structures physically and electrically connected to each of a first contact structure 1015 and a second contact structure 1017. In some embodiments, each of the first contact structure 1015 and the second contact structure 1017 is formed of copper. However, in other embodiments, each of the first contact structure 1015 and the second contact structure 1017 is formed of an electrically conductive material other than copper. The first contiguous tungsten bar via structure 1001A extends between the first contact structure 1015 and the second contact structure 1017 in a manner that is substantially parallel with the optical waveguide 1002. In some embodiments, the first contiguous tungsten bar via structure 1001A maintains a substantially uniform separation distance from the optical waveguide 1002 along the length of the optical waveguide 1002 between the first contact structure 1015 and the second contact structure 1017. The second contact structure 1017 is electrically connected to a third contact structure 1005 through a combination of via structures and metal interconnect structures within one or more higher levels of the photonic chip in which the microring resonator device 1000 is formed, as indicated by a structure 1023. In some embodiments, the third contact structure 1005 is formed of copper. However, in other embodiments, the third contact structure 1005 is formed of an electrically conductive material other than copper.

The second contiguous tungsten bar via structure 1001B includes a first group of bar via structures 1001B-1 physically and electrically connected to the third contact structure 1005. The second contiguous tungsten bar via structure 1001B also includes a second group of bar via structures 1001B-2 physically and electrically connected to the first group of bar via structures 1001B-1 by way of a bar via structure 1001B-c1. The second group of bar via structures 1001B-2 is configured to have a serpentine shape. The second group of bar via structures 1001B-2 is also configured to have a side of the second group of bar via structures 1001B-2 closest to the ring-shaped optical waveguide 1003 configured to have a shape that is substantially conformal with a curvature of the ring-shaped optical waveguide 1003. In some embodiments, a substantially uniform separation distance is established between the ring-shaped optical waveguide 1003 and the side of the second group of bar via structures 1001B-2 closest to the ring-shaped optical waveguide 1003 along the curvature of the ring-shaped optical waveguide 1003. The second contiguous tungsten bar via structure 1001B also includes a third group of bar via structures 1001B-3 physically and electrically connected to the second group of bar via structures 1001B-2 by way of a bar via structure 1001B-c2. The third group of bar via structures 1001B-3 are physically and electrically connected to a fourth contact structure 1007. In some embodiments, the fourth contact structure 1007 is formed of copper. However, in other embodiments, the fourth contact structure 1007 is formed of an electrically conductive material other than copper. The fourth contact structure 1007 is electrically connected to a fifth contact structure 1019 through a combination of via structures and metal interconnect structures within one or more higher levels of the photonic chip in which the microring resonator device 1000 is formed, as indicated by a structure 1025. In some embodiments, the fifth contact structure 1019 is formed of copper. However, in other embodiments, the fifth contact structure 1019 is formed of an electrically conductive material other than copper.

The third contiguous tungsten bar via structure 1001C includes a contiguous collection of bar via structures physically and electrically connected to each of the fifth contact structure 1017 and a sixth contact structure 1021. In some embodiments, the sixth contact structure 1021 is formed of copper. However, in other embodiments, the sixth contact structure 1021 is formed of an electrically conductive material other than copper. The third contiguous tungsten bar via structure 1001C extends between the fifth contact structure 1019 and the sixth contact structure 1021 in a manner that is substantially parallel with the optical waveguide 1004. In some embodiments, the third contiguous tungsten bar via structure 1001C maintains a substantially uniform separation distance from the optical waveguide 1004 along the length of the optical waveguide 1004 between the fifth contact structure 1019 and the sixth contact structure 1021. The sixth contact structure 1021 is electrically connected to a seventh contact structure 1009 through a combination of via structures and metal interconnect structures within one or more higher levels of the photonic chip in which the microring resonator device 1000 is formed, as indicated by a structure 1027. In some embodiments, the seventh contact structure 1009 is formed of copper. However, in other embodiments, the seventh contact structure 1009 is formed of an electrically conductive material other than copper.

The fourth contiguous tungsten bar via structure 1001D includes a first group of bar via structures 1001D-1 physically and electrically connected to the seventh contact structure 1009. The fourth contiguous tungsten bar via structure 1001D also includes a second group of bar via structures 1001D-2 physically and electrically connected to the first group of bar via structures 1001D-1 by way of a bar via structure 1001D-3. The second group of bar via structures 1001D-2 is configured to have a serpentine shape. The second group of bar via structures 1001D-2 is also configured to have a side of the second group of bar via structures 1001D-2 closest to the ring-shaped optical waveguide 1003 configured to have a shape that is substantially conformal with a curvature of the ring-shaped optical waveguide 1003. In some embodiments, a substantially uniform separation distance is established between the ring-shaped optical waveguide 1003 and the side of the second group of bar via structures 1001D-2 closest to the ring-shaped optical waveguide 1003 along the curvature of the ring-shaped optical waveguide 1003. The fourth contiguous tungsten bar via structure 1001D also includes a third group of bar via structures 1001D-4 physically and electrically connected to the second group of bar via structures 1001D-2 by way of a bar via structure 1001D-5. The third group of bar via structures 1001D-4 are physically and electrically connected to an eighth contact structure 1013. In some embodiments, the eighth contact structure 1013 is formed of copper. However, in other embodiments, the eighth contact structure 1013 is formed of an electrically conductive material other than copper.

Via structures in CMOS fabrication typically electrically connect the silicon device layer of the chip to the first metal interconnect layer (M1), such that electrical current flows vertically between the silicon device layer and the first metal interconnect layer (M1). In contrast to this typical function of via structures, the tungsten-via-based resistive heater 1001 is configured to direct a flow of electrical current horizontally through each of the first contiguous tungsten bar via structure 1001A, the second contiguous tungsten bar via structure 1001B, the third contiguous tungsten bar via structure 1001C, and the fourth contiguous tungsten bar via structure 1001D. More specifically, the tungsten-via-based resistive heater 1001 is configured so that electrical continuity is established from the first contact structure 1015 through the first contiguous tungsten bar via structure 1001A, through the second contact structure 1017, through the upper level electrically conductive structure 1023, through the third contact structure 1005, through the second contiguous tungsten bar via structure 1001B, through the fourth contact structure 1007, through the upper level electrically conductive structure 1025, through the fifth contact structure 1019, through the third contiguous tungsten bar via structure 1001C, through the sixth contact structure 1021, through the upper level electrically conductive structure 1027, through the seventh contact structure 1009, through the fourth contiguous tungsten bar via structure 1001D, to the eighth contact structure 1013.

A first voltage is applied to the first contact structure 1015 and a second voltage is applied to the eighth contact structure 1013. A voltage difference between the first voltage and the second voltage is controlled to cause a controlled flow of electrical current through the tungsten-via-based resistive heater 1001 between the first contact structure 1015 and the eighth contact structure 1013, which causes a controlled amount of heat generation within each of the first contiguous tungsten bar via structure 1001A, the second contiguous tungsten bar via structure 1001B, the third contiguous tungsten bar via structure 1001C, and the fourth contiguous tungsten bar via structure 1001D, which respectively heats the silicon structures 1031, 1006, 1033, and 1008. In some embodiments, the heat generated by portions of the tungsten-via-based resistive heater 1001 farther away from the ring-shaped optical waveguide 1003 (as indicated by the regions labeled “partially wasted heat”) has a lower effect on the optical performance of the microring resonator device 1000, e.g., lower contribution to thermo-optic phase shift, than heat generated by portions of the tungsten-via-based resistive heater 1001 closer to the ring-shaped optical waveguide 1003. Also, for a fixed electrical resistance of the tungsten-via-based resistive heater 1001, having both the first contiguous tungsten bar via structure 1001A below the ring-shaped optical waveguide 1003 and the third contiguous tungsten bar via structure 1001C above the ring-shaped optical waveguide 1003 increases the efficiency of the tungsten-via-based resistive heater 1001.

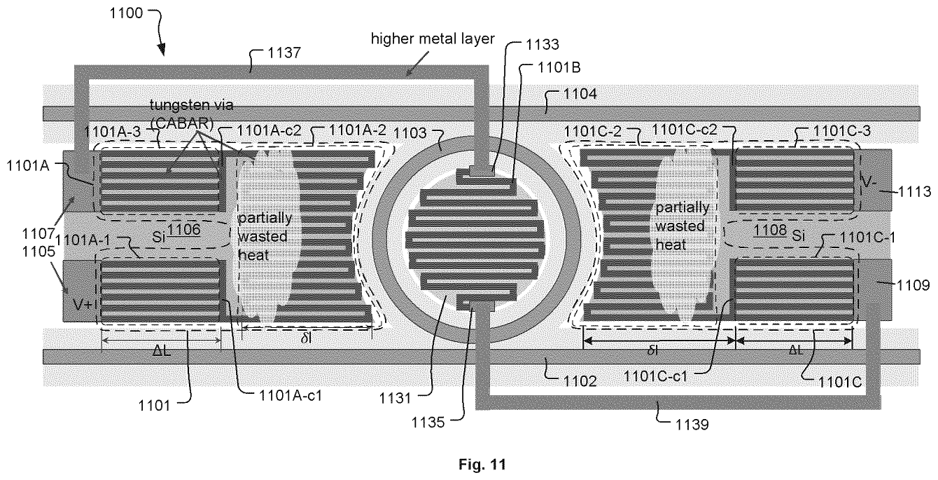

FIG. 11 shows a top view of a microring resonator device 1100 that implements a tungsten-via-based resistive heater 1101 both outside and inside of a ring-shaped optical waveguide 1003, in accordance with some embodiments. The microring resonator device 1100 is a combination of both the microring resonator device 800 of FIG. 8 and the microring resonator device 900 of FIG. 9. In some embodiments, the ring-shaped optical waveguide 1103 is positioned within an evanescent optical coupling distance of an optical waveguide 1102. In some embodiments, the ring-shaped optical waveguide 1103 is also positioned within an evanescent optical coupling distance of an optical waveguide 1104. The tungsten-via-based resistive heater 1101 is formed using rectangular-shaped bar vias made of tungsten. The tungsten-via-based resistive heater 1101 includes a first contiguous tungsten bar via structure 1101A on a first side of the ring-shaped optical waveguide 1103, a second contiguous tungsten bar via structure 1101B inside of the ring-shaped optical waveguide 1103, and a third contiguous tungsten bar via structure 1101C on a second side of the ring-shaped optical waveguide 1103. In some embodiments, the first contiguous tungsten bar via structure 1101A is formed over a silicon structure 1106. In some embodiments, the second contiguous tungsten bar via structure 1101B is formed over a silicon structure 1131. In some embodiments, the third contiguous tungsten bar via structure 1101C is formed over a silicon structure 1108.

The first contiguous tungsten bar via structure 1101A includes a first group of bar via structures 1101A-1 physically and electrically connected to a first contact structure 1105. In some embodiments, the first contact structure 1105 is formed of copper. However, in other embodiments, the first contact structure 1105 is formed of an electrically conductive material other than copper. The first contiguous tungsten bar via structure 1101A also includes a second group of bar via structures 1101A-2 physically and electrically connected to the first group of bar via structures 1101A-1 by way of a bar via structure 1101A-c1. The second group of bar via structures 1101A-2 is configured to have a serpentine shape. The second group of bar via structures 1101A-2 is also configured to have a side of the second group of bar via structures 1101A-2 closest to the ring-shaped optical waveguide 1103 configured to have a shape that is substantially conformal with a curvature of the ring-shaped optical waveguide 1103. In some embodiments, a substantially uniform separation distance is established between the ring-shaped optical waveguide 1103 and the side of the second group of bar via structures 1101A-2 closest to the ring-shaped optical waveguide 1103 and along the curvature of the ring-shaped optical waveguide 1103. The first contiguous tungsten bar via structure 1101A also includes a third group of bar via structures 1101A-3 physically and electrically connected to the second group of bar via structures 1101A-2 by way of a bar via structure 1101A-c2. The third group of bar via structures 1101A-3 are physically and electrically connected to a second contact structure 1107. In some embodiments, the second contact structure 1107 is formed of copper. However, in other embodiments, the second contact structure 1107 is formed of an electrically conductive material other than copper. The second contact structure 1107 is electrically connected to a third contact structure 1133 through a combination of via structures and metal interconnect structures within one or more higher levels of the photonic chip in which the microring resonator device 1100 is formed, as indicated by a structure 1137. The third contact structure 1133 is positioned inside of the ring-shaped optical waveguide 1103. In some embodiments, the third contact structure 1133 is formed of copper. However, in other embodiments, the third contact structure 1133 is formed of an electrically conductive material other than copper.

The second contiguous tungsten bar via structure 1101B is formed using contiguously formed rectangular-shaped bar vias made of tungsten. The second contiguous tungsten bar via structure 1101B is formed over the silicon structure 1131 within the region inside of the ring-shaped optical waveguide 1103. The second contiguous tungsten bar via structure 1101B is configured to have a substantially serpentine shape extending from the third contact structure 1133 to a fourth contact structure 1135. In some embodiments, the fourth contact structure 1135 is formed of copper. However, in other embodiments, the fourth contact structure 1135 is formed of an electrically conductive material other than copper. The fourth contact structure 1135 is electrically connected to a fifth contact structure 1109 through a combination of via structures and metal interconnect structures within one or more higher levels of the photonic chip in which the microring resonator device 1100 is formed, as indicated by a structure 1139. In some embodiments, the fifth contact structure 1109 is formed of copper. However, in other embodiments, the fifth contact structure 1109 is formed of an electrically conductive material other than copper.

The third contiguous tungsten bar via structure 1101C includes a first group of bar via structures 1101C-1 physically and electrically connected to the fifth contact structure 1109. The third contiguous tungsten bar via structure 1101C also includes a second group of bar via structures 1101C-2 physically and electrically connected to the first group of bar via structures 1101C-1 by way of a bar via structure 1101C-c1. The second group of bar via structures 1101C-2 is configured to have a serpentine shape. The second group of bar via structures 1101C-2 is also configured to have a side of the second group of bar via structures 1101C-2 closest to the ring-shaped optical waveguide 1103 configured to have a shape that is substantially conformal with a curvature of the ring-shaped optical waveguide 1103. In some embodiments, a substantially uniform separation distance is established between the ring-shaped optical waveguide 803 and the side of the second group of bar via structures 1101C-2 closest to the ring-shaped optical waveguide 1103 and along the curvature of the ring-shaped optical waveguide 1103. The third contiguous tungsten bar via structure 1101C also includes a third group of bar via structures 1101C-3 physically and electrically connected to the second group of bar via structures 1101C-2 by way of a bar via structure 1101C-c2. The third group of bar via structures 1101C-3 are physically and electrically connected to a sixth contact structure 1113. In some embodiments, the sixth contact structure 1113 is formed of copper. However, in other embodiments, the sixth contact structure 1113 is formed of an electrically conductive material other than copper.

Via structures in CMOS fabrication typically electrically connect the silicon device layer of the chip to the first metal interconnect layer (M1), such that electrical current flows vertically between the silicon device layer and the first metal interconnect layer (M1). In contrast to this typical function of via structures, the tungsten-via-based resistive heater 1101 is configured to direct a flow of electrical current horizontally through each of the first contiguous tungsten bar via structure 1101A, the second contiguous tungsten bar via structure 1101B, and the third contiguous tungsten bar via structure 1101C. More specifically, the tungsten-via-based resistive heater 1101 is configured so that electrical continuity is established from the first contact structure 1105 through the first contiguous tungsten bar via structure 1101A, through the second contact structure 1107, through the upper level electrically conductive structure 1137, through the third contact structure 1133, through the second contiguous tungsten bar via structure 1101B, through the fourth contact structure 1135, through the upper level electrically conductive structure 1139, through the fifth contact structure 1109, through the third contiguous tungsten bar via structure 1101C, through the sixth contact structure 1113. A first voltage is applied to the first contact structure 1105 and a second voltage is applied to the sixth contact structure 1113. A voltage difference between the first voltage and the second voltage is controlled to cause a controlled flow of electrical current through the tungsten-via-based resistive heater 1101 between the first contact structure 1105 and the sixth contact structure 1113, which causes a controlled amount of heat generation within each of the first contiguous tungsten bar via structure 1101A, the second contiguous tungsten bar via structure 1101B, and the third contiguous tungsten bar via structure 1101C, which heats the silicon structures 1106, 1131, and 1108, respectively.

In some embodiments, the heat generated by portions of the tungsten-via-based resistive heater 1101 farther away from the ring-shaped optical waveguide 1103 (as indicated by the regions labeled “partially wasted heat”) has a lower effect on the optical performance of the microring resonator device 1100, e.g., lower contribution to thermo-optic phase shift, than heat generated by portions of the tungsten-via-based resistive heater 1101 closer to the ring-shaped optical waveguide 1103. Also, for a fixed electrical resistance of the tungsten-via-based resistive heater 1101, having the second contiguous tungsten bar via structure 1101B inside of the ring-shaped optical waveguide 1103 in combination with having the first contiguous tungsten bar via structure 1101A and the third contiguous tungsten bar via structure 1101C outside of the ring-shaped optical waveguide 1103 increases the efficiency of the tungsten-via-based resistive heater 1101.

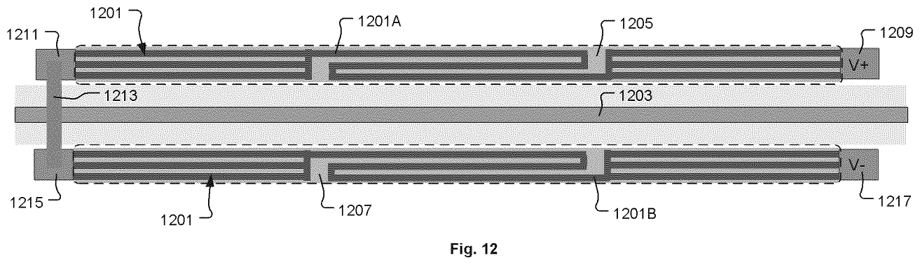

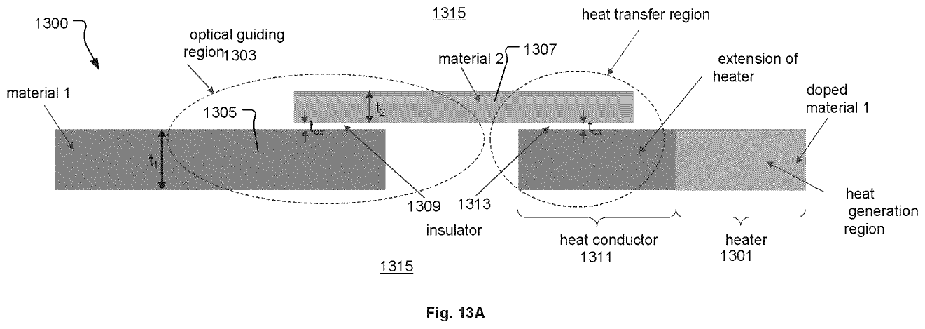

FIG. 12 shows a top view of a tungsten-via-based resistive heater 1201 formed along both sides of an optical waveguide 1203, in accordance with some embodiments. In some embodiments, the optical waveguide 1203 has a substantially linear shape. The tungsten-via-based resistive heater 1201 is formed using rectangular-shaped bar vias made of tungsten. The tungsten-via-based resistive heater 1201 includes a first contiguous tungsten bar via structure 1201A along a first side of the optical waveguide 1203, and a second contiguous tungsten bar via structure 1201B on a second side of the optical waveguide 1203. In some embodiments, the first contiguous tungsten bar via structure 1201A is formed over a silicon structure 1205. In some embodiments, the second contiguous tungsten bar via structure 1201B is formed over a silicon structure 1207.

The first contiguous tungsten bar via structure 1201A includes a contiguous collection of bar via structures physically and electrically connected to each of a first contact structure 1209 and a second contact structure 1211. In some embodiments, each of the first contact structure 1209 and the second contact structure 1211 is formed of copper. However, in other embodiments, each of the first contact structure 1209 and the second contact structure 1211 is formed of an electrically conductive material other than copper. The first contiguous tungsten bar via structure 1201A extends between the first contact structure 1209 and the second contact structure 1211 in a manner that is substantially parallel with the optical waveguide 1203. In some embodiments, the first contiguous tungsten bar via structure 1201A maintains a substantially uniform separation distance from the optical waveguide 1203 along the length of the optical waveguide 1203 between the first contact structure 1209 and the second contact structure 1211. The second contact structure 1211 is electrically connected to a third contact structure 1215 through a combination of via structures and metal interconnect structures within one or more higher levels of the photonic chip in which the optical waveguide 1203 is formed, as indicated by a structure 1213. The second contiguous tungsten bar via structure 1201B includes a contiguous collection of bar via structures physically and electrically connected to each of the third contact structure 1215 and a fourth contact structure 1217. In some embodiments, each of the third contact structure 1215 and the fourth contact structure 1217 is formed of copper. However, in other embodiments, each of the third contact structure 1215 and the fourth contact structure 1217 is formed of an electrically conductive material other than copper. The second contiguous tungsten bar via structure 1201B extends between the third contact structure 1215 and the fourth contact structure 1217 in a manner that is substantially parallel with the optical waveguide 1203. In some embodiments, the second contiguous tungsten bar via structure 1201B maintains a substantially uniform separation distance from the optical waveguide 1203 along the length of the optical waveguide 1203 between the third contact structure 1215 and the fourth contact structure 1217.

Via structures in CMOS fabrication typically electrically connect the silicon device layer of the chip to the first metal interconnect layer (M1), such that electrical current flows vertically between the silicon device layer and the first metal interconnect layer (M1). In contrast to this typical function of via structures, the tungsten-via-based resistive heater 1201 is configured to direct a flow of electrical current horizontally through each of the first contiguous tungsten bar via structure 1201A and the second contiguous tungsten bar via structure 1201B. More specifically, the tungsten-via-based resistive heater 1201 is configured so that electrical continuity is established from the first contact structure 1209 through the first contiguous tungsten bar via structure 1201A, through the second contact structure 1211, through the upper level electrically conductive structure 1213, through the third contact structure 1215, through the second contiguous tungsten bar via structure 1201B, to the fourth contact structure 1217. A first voltage is applied to the first contact structure 1209 and a second voltage is applied to the fourth contact structure 1217. A voltage difference between the first voltage and the second voltage is controlled to cause a controlled flow of electrical current through the tungsten-via-based resistive heater 1201 between the first contact structure 1209 and the fourth contact structure 1217, which causes a controlled amount of heat generation within each of the first contiguous tungsten bar via structure 1201A and the second contiguous tungsten bar via structure 1201B, which heats the silicon structures 1205 and 1207, respectively.

In various embodiments, a tungsten-via-based resistive heater, such as those described herein by way of example, is implementable with any optical waveguide geometry, such as ring-shaped optical waveguide (e.g., ring resonators) and linear-shaped optical waveguides, among others. In some conventional CMOS fabrication processes, design rule checking (DRC) may not allow for specification of long and serpentine-shaped tungsten via (CABAR) structures (shapes) on the chip, as needed to fabricate one or more of the tungsten-via-based resistive heaters disclosed herein. In some embodiments, in order to implement the tungsten-via-based resistive heaters disclosed herein, the following DRC waivers are specified, which include waivers for two severity level A DRC errors and five severity level B DRC errors:
1. {‘rulename’:‘GRCA.C.1’, ‘category’: ‘a’, ‘description’: ‘[CA CAREC (CABAR not over Union(TSVMOC GUARDRNG))] must be an orthogonal rectangle.--’, ‘error_count’: ‘1’}
2. {‘rulename’:‘GRCABAR.LW.1’, ‘category’: ‘a’, ‘description’: ‘(CABAR not over Union(TSVMOC GUARDRNG)) exact width==0.090 and (minimum 0.75 length maximum 1.05 1’, ‘error_count’: ‘1’}
3. {‘rulename’:‘GRCA.C.5’, ‘category’: ‘b’, ‘description’: ‘[(CA CABAR) touching PHOTON] must be within (PLP PLN).>=0.04’, ‘error_count’: ‘1’}
4. {‘rulename’:‘GRCABAR.C.2’, ‘category’: ‘b’, ‘description’: ‘[CABAR not over Union(CRACKSTOP GUARDRNG IND TSVMOC)] must be an orthogonal rectangle.--’, ‘error_count’: ‘1’}
5. {‘rulename’:‘GRCABAR.EN.M1’, ‘category’: ‘b’, ‘description’: ‘CABAR must be within M1. >=0.025’, ‘error_count’: ‘1’}
6. {‘rulename’:‘GRCABAR.EX.M1.1’, ‘category’: ‘b’, ‘description’: ‘M1 minimum overlap past [CABAR not over Union (CRACKSTOP GUARDRNG TSVMOC)] on two opposite sides with’, ‘error_count’: ‘1’}
7. {‘rulename’:‘GRCABAR.L.2’, ‘category’: ‘b’, ‘description’: ‘[CABAR not over Union (CRACKSTOP GUARDRNG IND TSVMOC)] maximum length. <=1’, ‘error_count’: ‘6’}

In some example embodiments, an electro-optical semiconductor chip includes a ring-shaped optical waveguide and a bus optical waveguide extending past the ring-shaped optical waveguide and within an evanescent optical coupling distance of the ring-shaped optical waveguide, such that an optical coupling region exists between the bus optical waveguide and the ring-shaped optical waveguide. Also, in these embodiments, the electro-optical semiconductor chip includes a tungsten-via-based resistive heater disposed outside of the ring-shaped optical waveguide on a silicon structure that is in thermal communication with the ring-shaped optical waveguide. The tungsten-via-based resistive heater includes a contiguous tungsten bar via structure formed on the silicon structure. In some embodiments, the contiguous tungsten bar via structure has a serpentine shape. In some embodiments, a side of the contiguous tungsten bar via structure closest to the ring-shaped optical waveguide has a shape that is conformal with a curvature of the ring-shaped optical waveguide. In some embodiments, a substantially uniform separation distance exists between the ring-shaped optical waveguide and the side of the contiguous tungsten bar via structure.

In some example embodiments, the tungsten-via-based resistive heater includes a first contact structure electrically connected to a first end of the contiguous tungsten bar via structure, and the tungsten-via-based resistive heater includes a second contact structure electrically connected to a second end of the contiguous tungsten bar via structure. A voltage differential between the first contact structure and the second contact structure controls an amount of electrical current flow through the contiguous tungsten bar via structure to control an amount of heat generated within the contiguous tungsten bar via structure to control a heating of the silicon structure on which the contiguous tungsten bar via structure is formed.

In some example embodiments, the above-mentioned contiguous tungsten bar via structure is a first contiguous tungsten bar via structure. In these embodiments, the above-mentioned silicon structure is a first silicon structure. In these embodiments, the tungsten-via-based resistive heater includes a second contiguous tungsten bar via structure disposed outside of the ring-shaped optical waveguide on a second silicon structure that is in thermal communication with the ring-shaped optical waveguide. In some of these embodiments, a position of the second contiguous tungsten bar via structure is diametrically opposed to a position of the first contiguous tungsten bar via structure relative to the ring-shaped optical waveguide.

In some of these embodiments, the tungsten-via-based resistive heater includes a third contact structure electrically connected to a first end of the second contiguous tungsten bar via structure, and the tungsten-via-based resistive heater includes a fourth contact structure electrically connected to a second end of the second contiguous tungsten bar via structure. A voltage differential between the third contact structure and the fourth contact structure controls an amount of electrical current flow through the second contiguous tungsten bar via structure to control an amount of heat generated within the second contiguous tungsten bar via structure to control a heating of the second silicon structure on which the second contiguous tungsten bar via structure is formed.

In some example embodiments, at least one upper level electrically conductive structure establishes an electrical connection between the second contact structure and the third contact structure. In these embodiments, a voltage differential between the first contact structure and the fourth contact structure is controlled to control an amount of electrical current flow through each of the first contiguous tungsten bar via structure and the second contiguous tungsten bar via structure to control an amount of heat generated within each of the first contiguous tungsten bar via structure and the second contiguous tungsten bar via structure to control a heating of each of the first silicon structure on which the first contiguous tungsten bar via structure is formed and the second silicon structure on which the second contiguous tungsten bar via structure is formed.

In some example embodiments, an electro-optical semiconductor chip includes a ring-shaped optical waveguide and a bus optical waveguide extending past the ring-shaped optical waveguide and within an evanescent optical coupling distance of the ring-shaped optical waveguide, such that an optical coupling region exists between the bus optical waveguide and the ring-shaped optical waveguide. In these embodiments, a contiguous tungsten bar via structure disposed inside of the ring-shaped optical waveguide on a silicon structure that is in thermal communication with the ring-shaped optical waveguide. In these embodiments, a first contact structure is electrically connected to a first end of the contiguous tungsten bar via structure. In these embodiments, a second contact structure is electrically connected to a second end of the contiguous tungsten bar via structure. A voltage differential between the first contact structure and the second contact structure controls an amount of electrical current flow through the contiguous tungsten bar via structure to control an amount of heat generated within the contiguous tungsten bar via structure to control a heating of the silicon structure on which the contiguous tungsten bar via structure is formed.

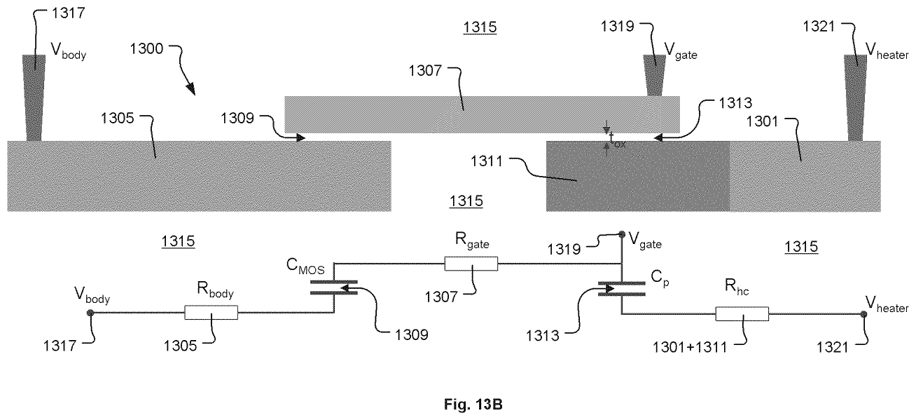

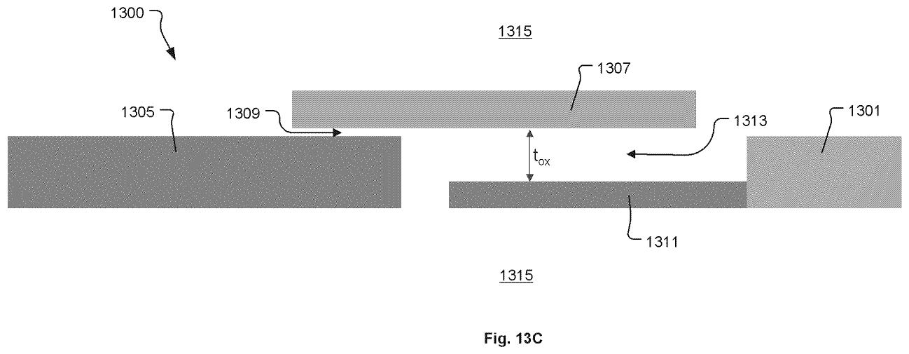

FIG. 13A shows a vertical cross-section through a thermo-optic phase shifter 1300, in accordance with some embodiments. For efficiency and reliability of the thermo-optic phase shifter 1300, a minimal temperature difference should be maintained between a heater 1301 and an optical guiding region 1303 of the thermo-optic phase shifter 1300, i.e., the ratio of the heater 1301 temperature (Tₕₜ) to the optical guiding region 1303 temperature (T_{wg}) should be as close to one as possible [(Tₕₜ/T_{wg})≈1]. In some embodiments, the heater 1301 is an Ohmic heater formed of a doped semiconductor material. The optical guiding region 1303 includes a first optical waveguide structure 1305, a second optical waveguide structure 1307 vertically stacked above the first optical waveguide structure 1305, and an electrical insulator material 1309 disposed in the vertical stack between the first optical waveguide structure 1305 and the second optical waveguide structure 1307. The first optical waveguide structure 1305, the second optical waveguide structure 1307, and the electrical insulator material 1309 collectively form a metal-oxide-semiconductor capacitor (MOSCAP) within the thermo-optic phase shifter 1300.

A high thermal conductivity path should be present between the heater 1301 and an optical guiding region 1303 within the thermo-optic phase shifter 1300. In this regard, the thermo-optical phase shifter 1300 includes a heat conductor 1311 thermally connected to the heater 1301. In some embodiments, the heat conductor 1311 is an extension of the heater 1301. In some embodiments, the heat conductor 1311 is formed of an undoped semiconductor material. In some embodiments, the heat conductor 1311 is formed of a doped semiconductor material. In some embodiments, the heat conductor 1311 is formed of a thermally conductive non-semiconductor material. The second optical waveguide structure 1307 of the optical guiding region 1303 is vertically stacked above the heat conductor 1311. An electrical insulator material 1313 is disposed in the vertical stack between the heat conductor 1311 and the second optical waveguide structure 1307. The heat conductor 1311 is configured to partially overlap the second optical waveguide structure 1307 in the horizontal direction. In some embodiments, the electrical insulator material 1313 has a vertical thickness (as measured perpendicularly between the heat conductor 1311 and the second optical waveguide structure 1307) within a range extending from about 1 nanometer to about 200 nanometers. The overlap area between the heat conductor 1311 and the second optical waveguide structure 1307 in the horizontal direction provides for efficient heat transfer from the heater 1301 through the heat conductor 1311 through the electrical insulator material 1313 to the second optical waveguide structure 1307, and to the optical guiding region 1303.

In some embodiments, the first optical waveguide structure 1305, the second optical waveguide structure 1307, the heat conductor 1311, and the heater 1301 are collectively surrounded by a low refractive index and low thermal conductivity material 1315, such as silicon dioxide (SiO₂), by way of example. In some embodiments, the surrounding low thermal conductivity material 1315, the electrical insulator material 1309, and the electrical insulator material 1313 is formed of the same material, such as silicon dioxide (SiO₂), by way of example. Each of the first optical waveguide structure 1305 and the second optical waveguide structure 1307 is formed of one or more material(s) that has a higher thermal conductivity than the surrounding low thermal conductivity material 1315. Also, in some embodiments, the each of the first optical waveguide structure 1305 and the second optical waveguide structure 1307 is formed of a semiconductor material, such as silicon (Si) by way of example, that has a higher thermal conductivity than the surrounding low thermal conductivity material 1315. In some embodiments, the electrical insulator material 1313 is a thin dielectric material, e.g., SiO₂, that electrically separates the second optical waveguide structure 1307 from the combination of the heater 1301 and the heat conductor 1311.

FIG. 13B shows the vertical cross-section through the thermo-optic phase shifter 1300 of FIG. 13A, along with an electrical schematic of the thermo-optic phase shifter 1300 corresponding to the physical structure of the thermo-optic phase shifter 1300, in accordance with some embodiments. The first optical waveguide structure 1305 is electrically connected to a body voltage potential (V_{body}) by way of an electrically conductive structure 1317, e.g., via structure 1317. The second optical waveguide structure 1307 is electrically connected to a gate voltage potential (V_{gate}) by way of an electrically conductive structure 1319, e.g., via structure 1319. The heater 1301 is electrically connected to a heater voltage potential (Vₕₑₐₜₑᵣ) by way of an electrically conductive structure 1321, e.g., via structure 1321. The first optical waveguide structure 1305 represents an electrical resistance (R_{body}). The second optical waveguide structure 1307 represents an electrical resistance (R_{gate}). The combination of the heater 1301 and heat conductor 1311 represents an electrical resistance (R_{hc}). The vertical stack of the first optical waveguide structure 1305, the electrical insulator material 1309, and the second optical waveguide structure 1307 electrically forms a first capacitor (C_{MOS}). The vertical stack of the second optical waveguide structure 1307, the electrical insulator material 1313, and the heat conductor 1311 electrically forms a second capacitor (Cₚ). In various embodiments, the MOSCAP waveguide structure corresponding to the first capacitor (C_{MOS}) is used as an electro-optic phase shifter for gigaHertz (GHz) frequency modulation. Also, it should be understood that the electrical insulator material 1313 between the second optical waveguide structure 1307 and the heat conductor 1311, along with the high electrical resistance of the heat conductor 1311 (formed of undoped semiconductor material), e.g., (R_{hc}→∞), provides for electrical isolation of the heater 1301 from the MOSCAP waveguide structure corresponding to the combination of the first optical waveguide structure 1305, the electrical insulator material 1309, and the second optical waveguide structure 1307.

FIG. 13C shows the vertical cross-section through the thermo-optic phase shifter 1300 of FIG. 13A, in which the vertical thickness (tₒₓ) of the electrical insulator material 1313 is increased, in accordance with some embodiments. Having the heat conductor 1311 positioned close to the second optical waveguide structure 1307 is desirable to optimize heat transfer efficiency between the heat conductor 1311 and the second optical waveguide structure 1307. However, in some embodiments, by having the heat conductor 1311 too close to the second optical waveguide structure 1307, undesirable optical coupling of light into the heat conductor 1311 may occur. In some embodiments, to prevent such undesirable optical coupling of light into the heat conductor 1311, the vertical thickness (tₒₓ) of the electrical insulator material 1313 is increased, as shown in FIG. 13C. In some embodiments, the heat conductor 1311 is partially etched to reduce its effective refractive index. Also, the increased in the vertical thickness (tₒₓ) of the electrical insulator material 1313 provides for better electrical isolation of the heater 1301 from the MOSCAP waveguide structure corresponding to the combination of the first optical waveguide structure 1305, the electrical insulator material 1309, and the second optical waveguide structure 1307.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

1. An electro-optical semiconductor chip, comprising:
a ring-shaped optical waveguide circumscribing an interior region of a microring resonator device;
a bus optical waveguide extending past the ring-shaped optical waveguide and within an evanescent optical coupling distance of the ring-shaped optical waveguide such that an optical coupling region exists between the bus optical waveguide and the ring-shaped optical waveguide;
a doped ring of silicon disposed within the interior region of the microring resonator device concentric with the ring-shaped optical waveguide;
an inner region of silicided silicon formed along an inner edge of the doped ring of silicon;
an outer region of silicided silicon formed along an outer edge of the doped ring of silicon;
a first plurality of electrical contacts disposed to electrically contact the outer region of silicided silicon; and
a second plurality of electrical contacts disposed to electrically contact the inner region of silicided silicon, wherein a voltage differential between the first plurality of electrical contacts and the second plurality of electrical contacts is used to control an electrical current flow through the doped ring of silicon to control a temperature of the ring-shaped optical waveguide.

2. The electro-optical semiconductor chip as recited in claim 1, wherein the doped ring of silicon, the inner region of silicided silicon, and the outer region of silicided silicon are formed as respective portions of a same monolithic silicon structure.

3. The electro-optical semiconductor chip as recited in claim 1, wherein the inner region of silicided silicon is ring-shaped, and the outer region of silicided silicon is ring-shaped.

4. The electro-optical semiconductor chip as recited in claim 3, wherein the doped ring of silicon, the inner region of silicided silicon, and the outer region of silicided silicon are formed as respective portions of a same monolithic silicon structure.

5. The electro-optical semiconductor chip as recited in claim 1, wherein the inner region of silicided silicon is disc-shaped, and the outer region of silicided silicon is ring-shaped.

6. The electro-optical semiconductor chip as recited in claim 5, wherein the doped ring of silicon, the inner region of silicided silicon, and the outer region of silicided silicon are formed as respective portions of a same monolithic silicon structure.

7. The electro-optical semiconductor chip as recited in claim 1, wherein the first plurality of electrical contacts are arranged in a substantially uniform distribution around the ring-shaped optical waveguide within the outer region of silicided silicon.

8. The electro-optical semiconductor chip as recited in claim 7, wherein the second plurality of electrical contacts are arranged in a substantially uniform distribution within the inner region of silicided silicon.

9. The electro-optical semiconductor chip as recited in claim 1, wherein the outer region of silicided silicon is spaced apart from the ring-shaped optical waveguide around an entire inner circumference of the ring-shaped optical waveguide.

10. The electro-optical semiconductor chip as recited in claim 9, wherein an oxide region is disposed between the outer region of silicided silicon and the ring-shaped optical waveguide around an entire inner circumference of the ring-shaped optical waveguide.

11. The electro-optical semiconductor chip as recited in claim 1, wherein the doped ring of silicon has a doping level set to achieve a target sheet electrical resistance within a range extending from about 70 ohms to about 250 ohms.

12. The electro-optical semiconductor chip as recited in claim 1, wherein the doped ring of silicon has a doping level set to achieve a target sheet electrical resistance within a range extending from about 100 ohms to about 20 ohms.

13. The electro-optical semiconductor chip as recited in claim 1, wherein the doped ring of silicon has a doping level set to achieve a target sheet electrical resistance within a range extending from about 1000 ohms per square-micrometer to about 8000 ohms per square-micrometer.

14. The electro-optical semiconductor chip as recited in claim 1, wherein the doped ring of silicon has a doping level set to achieve a target sheet electrical resistance within a range extending from about 2000 ohms per square-micrometer to about 5000 ohms per square-micrometer.

15. The electro-optical semiconductor chip as recited in claim 1, wherein the doped ring of silicon has a radial thickness within a range extending from about 0.1 micrometer to about 2 micrometers.

16. The electro-optical semiconductor chip as recited in claim 1, wherein the doped ring of silicon has a radial thickness within a range extending from about 0.2 micrometer to about 0.9 micrometer.

17. The electro-optical semiconductor chip as recited in claim 1, wherein the doped ring of silicon has a radial thickness within a range extending from about 0.3 micrometer to about 0.6 micrometer.

18. The electro-optical semiconductor chip as recited in claim 1, wherein the first plurality of electrical contacts is formed as a first dense collection of via structures configured to pull excess heat out of the outer region of silicided silicon, and wherein the second plurality of electrical contacts is formed as a second dense collection of via structures configured to pull excess heat out of the inner region of silicided silicon.

19. The electro-optical semiconductor chip as recited in claim 18, wherein the first dense collection of via structures includes at least 10 via structures, and wherein the second dense collection of via structures includes at least 10 via structures.

20. The electro-optical semiconductor chip as recited in claim 18, wherein the first dense collection of via structures has a cumulative via structure horizontal cross-section area of at least 0.1 square-micrometer, and wherein the second dense collection of via structures has a cumulative via structure horizontal cross-section area of at least 0.1 square-micrometer.

21. The electro-optical semiconductor chip as recited in claim 18, wherein the first dense collection of via structures has a cumulative via structure horizontal cross-section area of at least 0.15 square-micrometer, and wherein the second dense collection of via structures has a cumulative via structure horizontal cross-section area of at least 0.15 square-micrometer.

22. The electro-optical semiconductor chip as recited in claim 1, wherein the ring-shaped optical waveguide is a rib ring-shaped optical waveguide that includes a rib ring that has a full height, an outer silicon region that has a partial-height and surrounds the rib ring, and an inner silicon region that has a partial-height and is surrounded by the rib ring, wherein the rib ring, the outer silicon region, and the inner silicon region are integrally formed as respective portions of a same silicon structure, wherein the outer silicon region extends between the rib ring and the bus optical waveguide, and wherein the outer region of silicided silicon is spaced apart from the inner silicon region of the rib ring-shaped optical waveguide.

23. The electro-optical semiconductor chip as recited in claim 22, wherein an oxide region is disposed between the outer region of silicided silicon and the inner silicon region of the rib ring-shaped optical waveguide.

24. The electro-optical semiconductor chip as recited in claim 23, wherein the oxide region has a non-zero radial thickness within a range extending up to about 200 nanometers.

25. The electro-optical semiconductor chip as recited in claim 1, wherein said bus optical waveguide is a first bus optical waveguide and said optical coupling region is a first optical coupling region, the electro-optical semiconductor chip further including a second bus optical waveguide extending past the ring-shaped optical waveguide and within an evanescent optical coupling distance of the ring-shaped optical waveguide such that a second optical coupling region exists between the second bus optical waveguide and the ring-shaped optical waveguide.

26. The electro-optical semiconductor chip as recited in claim 25, wherein the first optical coupling region and the second optical coupling region are diametrically opposed to each other relative to the ring-shaped optical waveguide.
